(19) United States
(12) Patent Application Publication
(10) Pub. No.: US 2026/0031935 A1
(43) Pub. Date: Jan. 29, 2026

(54) PACKET DATA CONVERGENCE PROTOCOL RETRANSMISSION FOR CELL-FREE CONNECTIVITY

(71) Applicant: APPLE INC., Cupertino, CA (US)

(72) Inventors: Danila Zaev, Munich (DE); Naveen Kumar R. Palle Venkata, San Diego, CA (US); Ahmed Gamal Helmy Mohamed, Cupertino, CA (US); Kenza Hamidouche, Cupertino, CA (US); Ralf Rossbach, Munich (DE); Norman Goris, Dortmund (DE); Ayman F. Naguib, Cupertino, CA (US)

(21) Appl. No.: 19/258,094

(22) Filed: Jul. 2, 2025

Related U.S. Application Data
(60) Provisional application No. 63/676,481, filed on Jul. 29, 2024.

(51) Int. Cl. H04L 1/1812; H04W 28/02; H04W 28/06

(52) U.S. Cl. CPC H04L 1/1816; H04W 28/0268; H04W 28/06

(57) ABSTRACT

Apparatus and methods are provided for PDCP retransmission. A Tx PDCP entity generates a Tx request message including an ID of the Tx request message, Tx request configuration information, and one or more groups of PDUs. In response, a Tx UM RLC function determines one or more delivered PDUs and one or more non-delivered PDUs within a TTL period configured by the Tx request configuration information. The Tx UM RLC function generates a delivery Tx report based on the one or more delivered PDUs and the one or more non-delivered PDUs. The delivery Tx report is associated with the ID of the Tx request message. After expiration of a TTR period configured by the Tx request configuration information, the delivery Tx report is sent to the Tx PDCP entity. In response to the delivery Tx report, the Tx PDCP entity determines to retransmit the one or more non-delivered PDUs.

### TECHNICAL FIELD

This application relates generally to wireless communication systems, including cell-free networks.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station (BS) of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g-Node-B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram illustrating example clustering in a cell-free network architecture used in certain embodiments.

FIG. 2 is a diagram illustrating an example radio protocol architecture used in cell-free networks, according to certain embodiments.

FIG. 3 illustrates an example of resource allocation for a MAC configuration of a single UE used in certain embodiments.

FIG. 4 illustrates an example of resource allocation of a multi-MAC UE used in certain embodiments.

FIG. 5 illustrates an example of a Layer 2 architecture using MAC towers in cell-free networks, according to certain embodiments.

FIG. 6A and FIG. 6B illustrate example MAC and RLC relationships, according to certain embodiments.

FIG. 7 is a block diagram illustrating a unified solution including PDCP with retransmission based on request and report procedures, according to certain embodiments.

FIG. 8 is a block diagram illustrating an overview of several elements used for PDCP transmission and retransmission, according to certain embodiments.

FIG. 9 is a signal diagram illustrating transmission requests, according to certain embodiments.

FIG. 10 is a block diagram illustrating a split centralized unit/distributed unit base station architecture that may be used in certain embodiments.

FIG. 11 illustrates a multi-group transmission request, according to certain embodiments.

FIG. 12A, FIG. 12B, and FIG. 12C illustrate different options for a Tx PDCP entity to configure a TTL timer for a Tx RLC/MAC entity, according to certain embodiments.

FIG. 13 is a flow diagram illustrating an example RLC TTL-based discard process, according to certain embodiments.

FIG. 14 is a signal diagram illustrating an example delivery Tx report, according to certain embodiments.

FIG. 15 is a signal diagram illustrating use of a wait timer, according to certain embodiments.

FIG. 16 is a block diagram illustrating PDCP functionality to support multi-link operation, according to certain embodiments.

FIG. 17 is a signal diagram illustrating smart duplication, according to certain embodiments.

FIG. 18 is a signal diagram illustrating duplication with discard, according to certain embodiments.

FIG. 19 is a signal diagram illustrating link switching, according to certain embodiments.

FIG. 20 is a block diagram illustrating MAC PDU allocation of MAC SDUs from the same logical channel but with various remaining TTL time budgets, according to certain embodiments.

FIG. 21 is a flowchart of a method for PDCP retransmission for cell-free connectivity of a wireless device, according to certain embodiments.

FIG. 22 illustrates an example architecture of a wireless communication system, according to embodiments disclosed herein.

FIG. 23 illustrates a system for performing signaling between a wireless device and a network device as supported by a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some wireless communication systems, a cell-free network architecture provides an adaptive/dynamic and UE-centric distribution of functionalities that may be associated with a “serving cell” as understood in the context of prior cell-based network architectures (e.g., an NR network architecture or an LTE network architecture). Certain embodiments disclosed herein provide packet data convergence protocol (PDCP) retransmission for cell-free connectivity of a wireless device. The wireless device may be, for example, a UE or a base station. A transmission (Tx) PDCP entity associated with or configured for the wireless device provides a Tx request message to a Tx unacknowledged mode (UM) radio resource control (RLC) function associated with or configured for the wireless device. In certain embodiments, the Tx PDCP entity and/or the Tx UM RLC function may be part of the wireless device. For example, the Tx PDCP entity and/or the Tx UM RLC function may be implemented in one or more baseband processors of a UE. In other embodiments, on the network side, the Tx PDCP entity and/or the Tx UM RLC function may be implemented in one or more nodes that are separate from the wireless device. For example, the Tx PDCP entity and/or the Tx UM RLC function may be implemented in a centralized unit (e.g., one or more cloud edge nodes). As another example, the Tx PDCP entity may be implemented in a first network node and the Tx UM RLC function may be implemented in a second network node.

The Tx UM RLC function may be implemented, for example, in a Tx UM RLC entity of the wireless device and/or a media access control (MAC) entity of the wireless device. For example, the UM/TM RLC functionality may be merged with the MAC layer (e.g., a buffer within the MAC entity that implements UM/TM functionality). Thus, as used herein, the Tx UM RLC function may be referred to simply as an RLC/MAC or an UM/TM RLC entity.

The Tx request message may include an identifier (ID) of the Tx request message, Tx request configuration information, and one or more groups of protocol data units (PDUs) in a PDCP Tx buffer of the wireless device. The Tx request configuration information may indicate a time-to-live (TTL) period and a time-to-report (TTR) period. In response to the Tx request message, the Tx UM RLC function of the wireless device determines one or more delivered PDUs and one or more non-delivered PDUs within the TTL period configured by the Tx request configuration information and generates a delivery Tx report based on the one or more delivered PDUs and the one or more non-delivered PDUs. After expiration of a time-to-report period configured by the Tx request configuration information, the Tx UM RLC function sends the delivery Tx report to the Tx PDCP entity. In response to the delivery Tx report, the Tx PDCP entity determines whether or not to retransmit the one or more non-delivered PDUs.

### Example Clustering in Cell-Free Networks

With respect to the present disclosure, it may be understood generally that a “cluster” or “serving cluster” of a UE is a set of physically and/or logically connected base stations over which functionalities related to the serving UE (e.g., traditional serving cell functionalities used in cell-based network architectures) may be distributed. Accordingly, (the concept of) a cluster may, under some perspectives, “replace” (the concept of) a serving cell of a UE as understood for prior cell-based networks.

A cluster may have a one-to-one mapping with a UE. Thus, separate (logical) clusters for each of two UEs may be understood/cognizable (even when each of the two corresponding clusters is made up of the same physical set of base stations). Further, note that a single base station may simultaneously belong to multiple clusters that each serve different UEs.

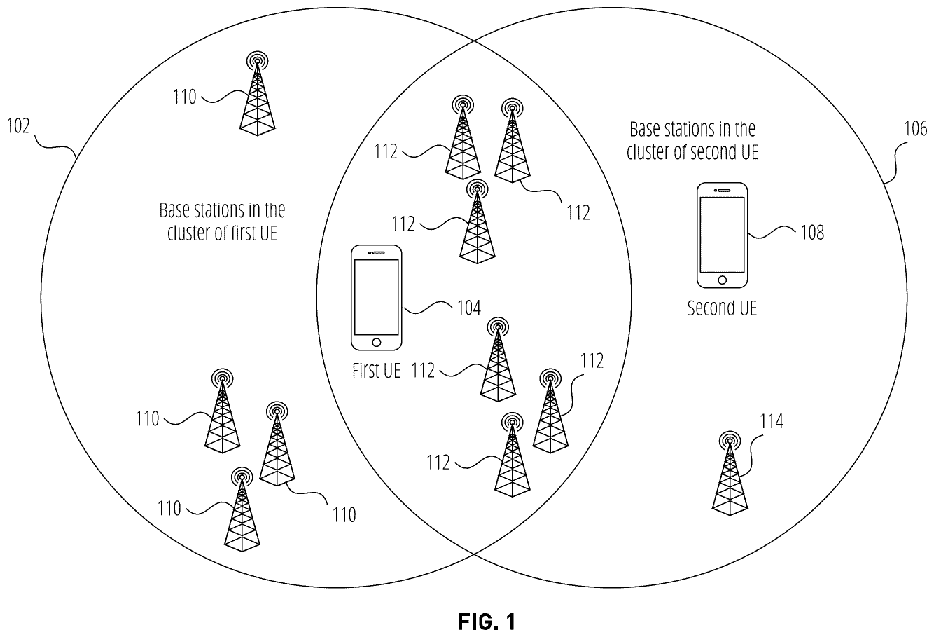

FIG. 1 illustrates a diagram for an example of clustering in a cell-free network architecture. A first cluster 102 of base stations serves a first UE 104 and a second cluster 106 of base stations serves the second UE 108. As illustrated, the first cluster 102 includes the first base stations 110 and the second base stations 112, while the second cluster 106 includes the second base stations 112 and the third base station 114.

Base stations in a same cluster are not necessarily required to jointly transmit/receive to/from the UE being served. Further, control plane and/or user plane functionalities may be dynamically distributed among the base stations in the cluster.

A clustering control function (CCF) may be defined as one or more logical function sets for the establishment and control of clusters in the wireless communication system. The CCF may be a distributed entity of the wireless communication system. For example, the CCF may be distributed across one or more of the core networks, a RAN intelligent controller (RIC), and/or one or more base station(s) of the RAN.

The CCF may dynamically develop, update, control, and schedule UE-centric connected sets of clusters in certain geographical areas based on, for example: traffic, latency, reliability, coverage, interference, sensing, mobility, cell load, radio resource management (RRM) aspects, radio link quality, backhaul ideality, location, quality of service (QoS) requirements, and/or measurement reports, etc.

In some wireless communication systems, clustering in cell-free networks includes concepts such as a UE-centric cluster, a CCF, connected base stations (cBSs) (e.g., base stations that are part of a cluster serving a UE), neighboring un-connected base stations (uBSs) (e.g., neighboring base stations to a UE that are not currently part of a cluster serving the UE), etc. In some such systems, a CCF includes functionalities, protocols, message exchange capabilities, and the like that may be used for cluster establishment and/or update tasks (among other things). UEs and base stations may include corresponding functionalities, protocols, message exchange capabilities, and the like supporting the use of clustering as described herein.

In wireless communication systems implementing cell-free networks, it may be that cell-free radio resource control (RRC) connection establishment and maintenance messaging protocols are used. This may mean, among other things, that an RRC state of a UE is understood with respect to the network generally (rather than with respect to a particular serving cell).

Further, such wireless communication systems for cell-free networks may use one or more cluster establishment options corresponding to an initial access of the UE and/or to cluster updating mechanisms (e.g., that control the composition of base stations in the cluster after the UE's initial access). These may include, for example, “greedy,” downlink (DL)-based, uplink (UL)-based, and/or real-time methodologies (and any corresponding message exchanges).

### Example Radio Protocol in Cell-Free Networks

In some wireless communication systems, “cluster partitioning” represents a radio-bearer-specific dynamic partition of a cluster serving a UE into logical sub-clusters. Such a cluster partitioning into sub-clusters may be determinative of a protocol stack architecture that applies with respect to that cluster. For example, sub-clusters according to the partitioning may be in one-to-one correspondence with RLC entities. Base stations in a same sub-cluster may then, for example, each carry copy of the same logical RLC entity for a given radio bearer.

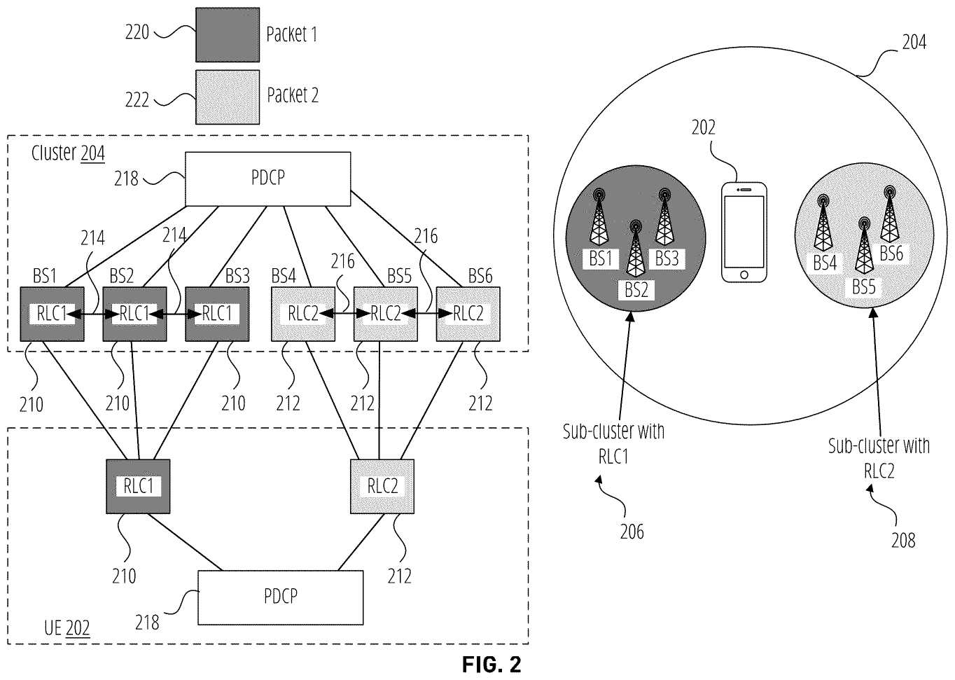

FIG. 2 illustrates a diagram showing aspects of radio protocol use in cell-free network mechanisms. A UE 202 is served by a cluster 204. Within the cluster 204, there is a first sub-cluster 206 that corresponds to a first RLC entity 210 used between the UE 202 and the cluster 204 and a second sub-cluster 208 that corresponds to a second RLC entity 212 between the UE 202 and the cluster 204. The first RLC entity 210 and the second RLC entity 212 are RLC entities used by a PDCP entity 218 that corresponds to a radio bearer between the UE 202 and the cluster 204 and that uses the illustrated cluster partitioning.

As illustrated, the first RLC entity 210 is synchronized 214 across the base stations of the first sub-cluster 206 (BS1, BS2, and BS3). This means that, for example, each of these base stations has and operates according to a copy of the first RLC entity 210, as shown. Further, the second RLC entity 212 is synchronized 216 across the base stations of the second sub-cluster 208 (BS4, BS5, and BS6). This means that, for example, each of these base stations has and operates according to a copy of the second RLC entity 212, as shown. Note that, as illustrated, the arrangement of particular base stations of the cluster into the first sub-cluster 206 or second sub-cluster 208 may be transparent to the UE (the UE knows about/operates in terms of the first RLC entity 210 and the second RLC entity 212 (in terms of the sub-clusters), without consideration with respect to particular base stations underlying those RLC entities/sub-clusters).

In the illustrated case, a first packet 220 (shown as Packet 1) of the radio bearer corresponding to the PDCP entity 218 is handled at the first RLC entity 210. This ultimately means that the first packet 220 is communicated between the UE 202 and the cluster 204 via one or more of the base stations of the first sub-cluster 206. Further, a second packet 222 (shown as Packet 2) of the (same) radio bearer corresponding to the PDCP entity 218 is handled at the second RLC entity 212. This ultimately means that the second packet 222 is communicated between the UE 202 and the cluster 204 via one or more of the base stations of the second sub-cluster 208.

It is contemplated that a cluster partitioning may be updated over time. Establishment and/or updating of a cluster partitioning may take into account QoS requirements and traffic properties associated with a radio bearer. For example, latency constraints, and/or traffic periodicity may be considered. These mechanisms allow the network (e.g., a CCF) to optimally configure sub-cluster-enabled multi-connectivity of a UE to a cluster in, for example, a non-ideal backhaul scenario (where different partitionings of a same cluster may have appreciably different QoS/traffic management characteristics).

In some wireless communication systems, radio protocols in cell-free networks utilize concepts such as cluster partitioning/sub-clusters, RLC synchronization, etc. A functionality for control over dynamically updating cluster partitions, and a corresponding protocol for the update procedure, may be used. PDCP data routing options and a corresponding configuration may be used. Finally, a cell-free radio bearer configuration and/or a message exchange procedure for radio bearer establishment may be used.

### Example Cell-Free MAC Scheduling

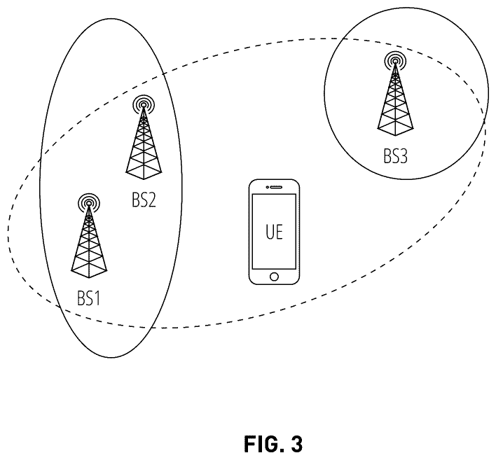

FIG. 3 illustrates an example of resource allocation of a multi-BS MAC. In this example, a UE is shown in relation to a first base station (BS1), a second base station (BS2), and a third base station (BS3). In some wireless communication systems, resource allocation of a multi-BS MAC is assumed to be made jointly by the BSs within a multi-BS MAC. In the illustrated example, the decision is made by one of the BSs (e.g., BS1) and provided to BS2 via Xn interface. Because of the Xn latency, the resource allocation decision should be made for the transmission time interval (TTI) in the future (by at least Xn latency time). This adds Xn latency to the scheduling latency. Joint resource allocation may provide high spectral efficiency, but it adds latency. It can be a good choice for latency-tolerant traffic.

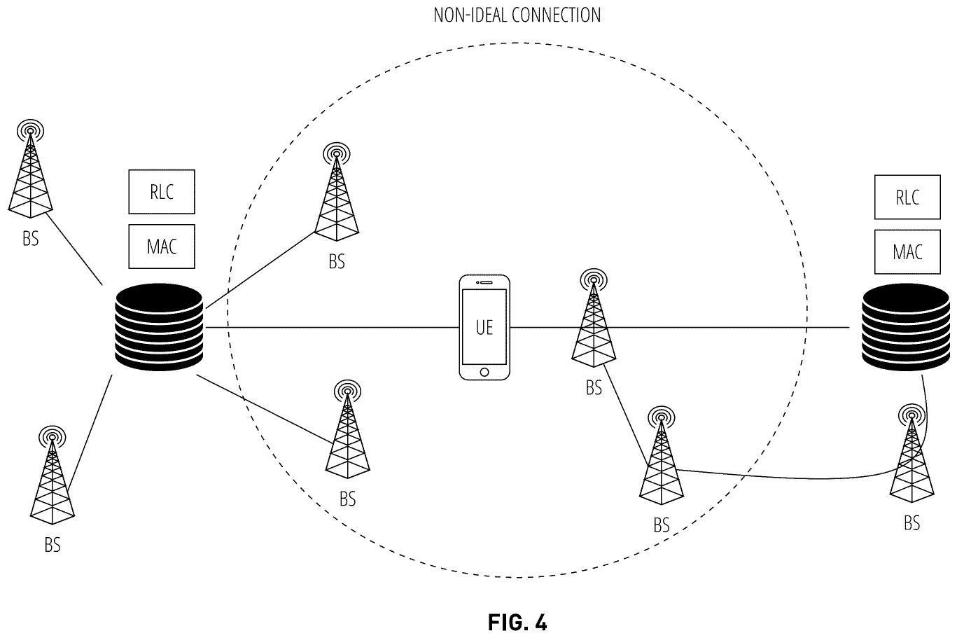

FIG. 4 illustrates an example of resource allocation of a multi-MAC UE. In some wireless communication systems, resource allocation of multi-MAC UEs is assumed to be made in a decentralized manner by the BSs of different MACs of the same UE. First, the BSs may agree about a coordinated allocation pattern, in time domain, frequency domain and/or spatial domain for a period of time. As an example, they can agree to let a first MAC to be scheduled at even TTIs, and a second MAC to be scheduled at odd TTIs. In other examples, they can be to agree the coordination in frequency band or in a spatial domain for multi-antenna UEs. Note that, in real-time, each BS may decide to schedule a MAC in compliance with the coordinated allocation pattern. Decentralized scheduling does not add latency but may achieve less spectral efficiency compared with joint decision option.

### Example Layer 2 Architecture using MAC Towers in Cell-Free Networks

In some embodiments, a set of MACs can be configured as a “MAC tower” when the MACs have a single common base station and/or when the MACs are connected with the same set of RLC entities. In certain such embodiments, a MAC entity belongs to a single MAC tower, MACs of the same MAC tower are physically implemented at the same shared base station, MACs of the same MAC tower may coordinate their grant allocation decisions with each other in the real time, different MAC towers may provide grants without real-time synchronization with each other, MACs of the same MAC tower share the same HARQ processes, and/or MAC towers at the network side and MAC entities at UE side are in one-to-one correspondence.

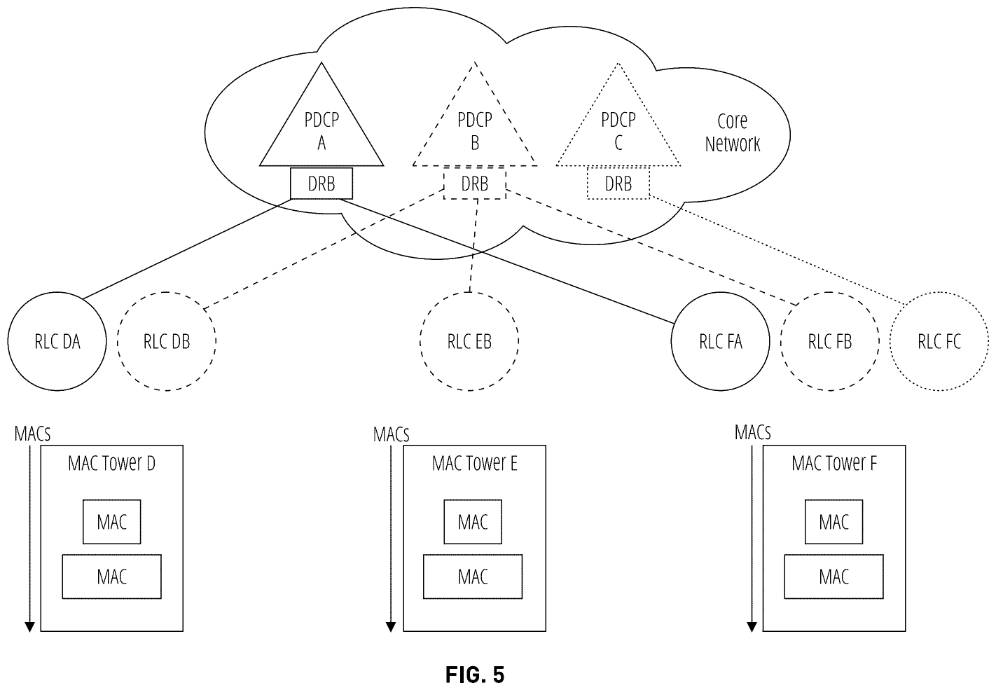

FIG. 5 illustrates an example of a Layer 2 architecture using MAC towers in cell-free networks, according to certain embodiments. In the illustrated example, which is from a network perspective, PDCP entities (shown as PDCP A, PDCP B, and PDCP C) are implemented close to a user plane function (not shown) in a core network (or data center) following re-allocation procedures (e.g., 5G session and service continuity). Forward error correction (FEC) coding (or erasure code) may be implemented at the PDCP layer on top of multiple wireless links. As shown, each PDCP entity and its associated data radio bearer (DRB) may be configured with multiple RLC entities. For example, PDCP A is configured with RLC DA for MAC tower D and RLC FA for MAC tower F. Similarly, PDCP B is configured with RLC DB for MAC tower D, RLC EB for MAC tower E, and RLC FB for MAC tower F. Further, in this example, PDCP C is configured with RLC FC for MAC tower F. A many-to-many relationship for RLC entities may be established when a Layer 2 protocol stack is configured or reconfigured. For DRBs with low-latency requirements, RLCs are typically configured in TM or UM.

Each MAC tower may have a single MAC entity counterpart at the UE side and HARQ processes may be implemented per MAC tower. An RLC buffer can be created for a pair (e.g., DRB, MAC tower). The RLC buffer and the associated MAC tower may reside at the same base station to allow communication with no additional latency. In certain embodiments, a copy of the RLC buffer is available at each base station of a Max Set of the associated MAC tower, where the Max Set is a maximum set of base stations in a cluster that can be used by the MAC tower for resource allocation.

### Example MAC and UM/TM RLC Relationships

In some wireless communication systems, RLC and MAC may have a low-delay connection at the network side. As a result, the UM/TM RLC buffer may be considered as a part of the MAC entity to reduce implementation and signaling overhead and provide the MAC with higher control over the buffer. In certain embodiments, the UM RLC functionality of segmentation/reassembly may be supported; and, in cases of RLC-MAC merging, segmentation sequencing numbers (SN) may be placed in MAC PDU sub-headers.

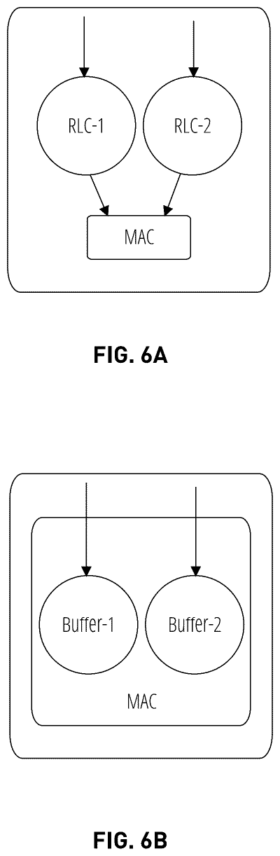

In certain embodiments, a single MAC may be connected to multiple RLC entities. For example, FIG. 6A illustrates a MAC connected to two RLC entities (shown as RLC-1 and RLC-2) that are associated with different radio bearers (not shown). In other embodiments, a single MAC may include multiple RLC buffers that are related to different radio bearers. For example, FIG. 6B illustrates a MAC with two buffers (shown as Buffer-1 and Buffer-2) that are associated with different radio bearers (not shown).

### PDCP Retransmission Overview

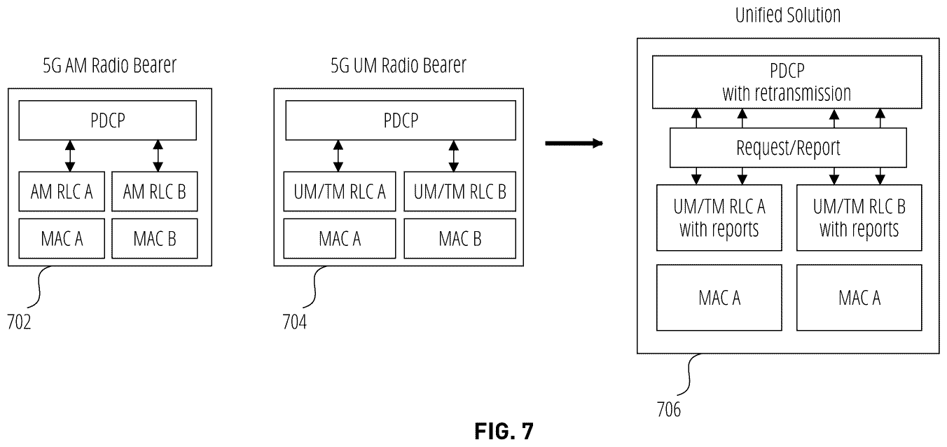

Certain wireless networks, such as 5G networks, support acknowledged mode (AM) radio bearers and unacknowledged mode (UM) radio bearers. For example, FIG. 7 is a block diagram illustrating a 5G AM radio bearer 702 and a 5G UM radio bearer 704. In this example, the 5G AM radio bearer 702 includes two AM RCL entities and associated MAC entities (shown as AM RLC A associated with MAC A and AM RLC B associated with MAC B). However, a different number of RLC and MAC entities may be used. The 5G AM radio bearer 702 may provide guaranteed delivery of downlink packets. However, the 5G AM radio bearer 702 may have an inefficient multi-link operation that introduces longer delays and higher reordering of packets. Thus, it may be difficult to predict a data rate at each leg to balance the data split between them. Further, the 5G AM radio bearer 702 may not be efficient for latency-sensitive applications (e.g., RLC retransmissions may be too late in some cases).

In the illustrated example, the 5G UM radio bearer 704 includes two UM/TM RLC entities and associated MAC entities (shown as UM/TM RLC A associated with MAC A and UM/TM RLC B associated with MAC B). However, a different number of RLC and MAC entities may be used. The 5G UM radio bearer 704 may be more efficient, as compared to the 5G AM radio bearer 702, for latency-sensitive applications. However, the 5G UM radio bearer 704 cannot support guaranteed delivery of packets. Further, the multi-link operation provided by the 5G UM radio bearer 704 is efficient only with packet duplication (or FEC packet coding). Without duplication and/or FEC, the 5G UM radio bearer 704 requires accurate data rate prediction, which is not available in many cases.

Thus, as shown in FIG. 7, certain embodiments disclosed herein provide a unified solution 706 including PDCP with retransmission based on request and report procedures.

In the illustrated example, the unified solution 706 includes two UM/TM RLC entities and associated MAC entities (shown as UM/TM RLC A with reports associated with MAC A and UM/TM RLC B with reports associated with MAC B). However, a different number of RLC and MAC entities may be used. In certain embodiments, the unified solution 706 supports guaranteed delivery of packets, sufficient efficiency for latency-sensitive applications, and/or efficient multi-link operation with or without packet duplication.

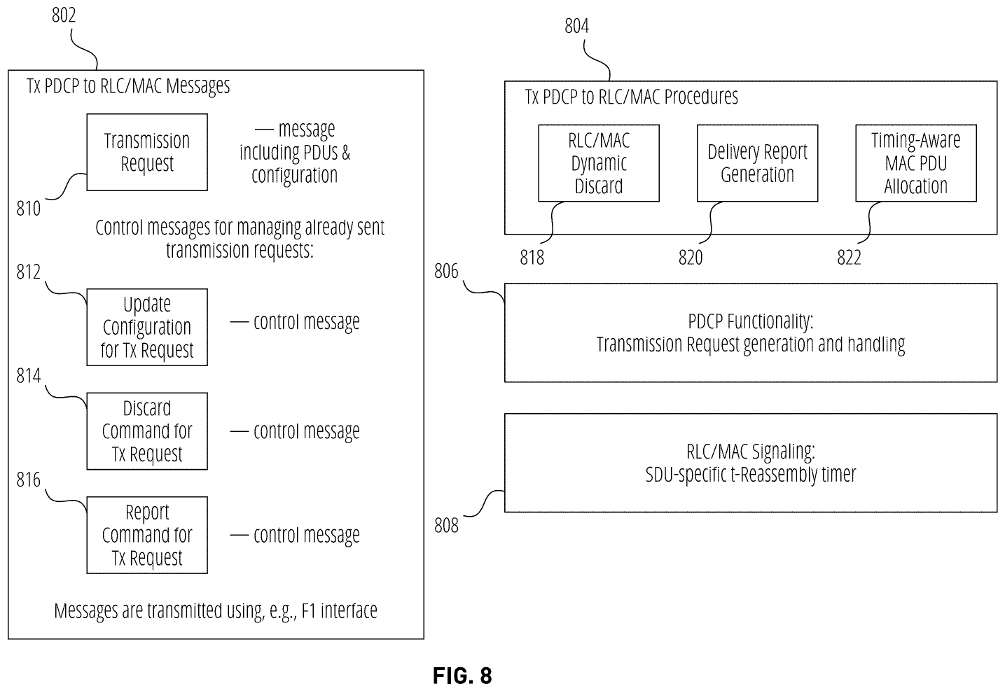

FIG. 8 is a block diagram illustrating an overview of several elements used for PDCP transmission (Tx) and retransmission (ReTx), according to certain embodiments. Some embodiments may use two or more of the illustrated elements in combination to implement flexible retransmission at the PDCP layer, which enhances multi-link operation. As discussed in detail herein, the elements include Tx PDCP to RLC/MAC messages 802, Tx PDCP to RLC/MAC procedures 804, PDCP functionality 806, and RLC/MAC signaling 808.

The Tx PDCP to RLC/MAC messages 802 include a transmission request 810 comprising messages with PDUs and configuration information. The transmission request 810 may also include control messages for managing already sent transmission requests including, for example, an update configuration for Tx request 812, a discard command for Tx request 814, and/or a report command for Tx request 816. The Tx PDCP to RLC/MAC messages 802 may be transmitted using, for example, an F1 interface.

As discussed below, the Tx PDCP to RLC/MAC procedures 804 may include RLC/MAC dynamic discard 818, delivery report generation 820, and/or timing-aware MAC PDU allocation 822. The PDCP functionality 806 includes transmission request generation and functionality. In certain embodiments, the RLC/MAC signaling 808 includes sending information related to a service data unit (SDU)-specific t-Reassembly timer.

### Transmission Request

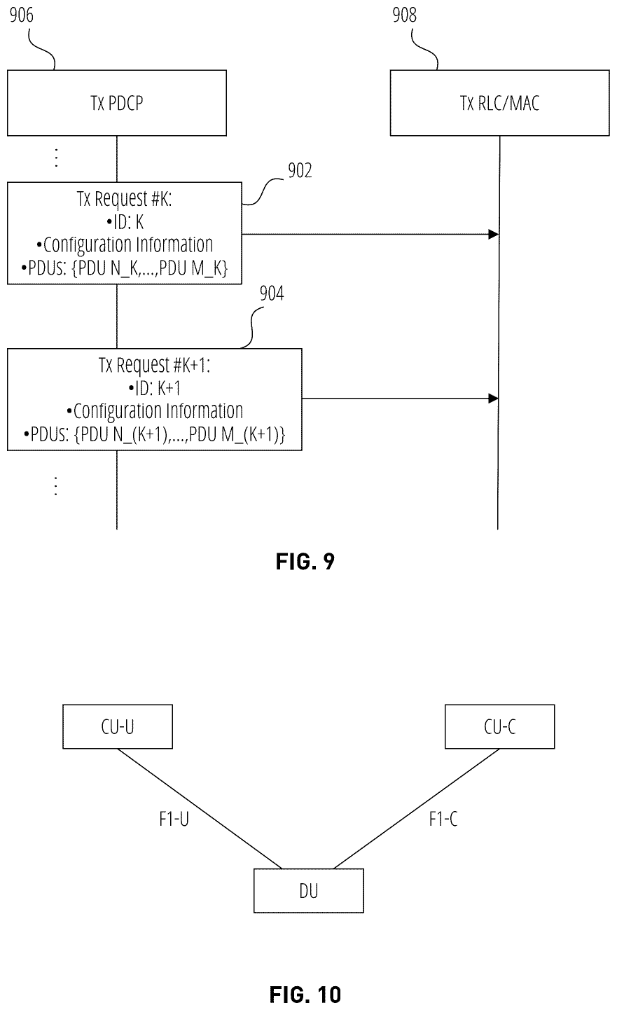

FIG. 9 is a signal diagram illustrating transmission requests, according to certain embodiments. While any number of Tx requests may be used, for simplicity the illustrated example shows a first Tx request message 902 with ID “K” (shown as Tx Request #K) and a second Tx request message 904 with ID “K+1” (shown as Tx Request #K+1) in a series of requests sent from a Tx PDCP entity 906 to a Tx RLC/MAC entity 908.

The Tx request messages each include a respective ID (e.g., K, K+1, etc.) for the Tx request message, Tx request configuration information, and one or more groups of PDUs. For example, the first Tx request message 902 comprises a first group of PDUs {PDU N_K, . . . , PDU M_K} and the second Tx request message 904 comprises a second group of PDUs {PDU N_(K+1), . . . , PDU M_(K+1)}. A group of PDUs may be a subset of PDUs that are located in a PDCP buffer at the moment of request generation. It should be noted that a relation should not be assumed between a group of PDUs and a “PDU Set” used in various communication systems, as the concepts are different. However, in some PDCP implementations, a PDU group and the corresponding configuration information may be selected based on PDU Set information.

The ID of a Tx request may be unique per each RLC/MAC entity at any given moment of time. If several PDCP entities operate with an RLC/MAC, the ID of a Tx request might include an ID of the PDCP entity to avoid ID collisions.

In certain embodiments, Tx request configuration information includes a time-to-live (TTL) timer configuration and a time-to-report timer (TTR) configuration. Further TTL, TTR, and other protocol details are provided below.

In certain embodiments, on the network side, the Tx requests are transmitted through, e.g., an F1 interface (F1-U or F1-C). For example, FIG. 10 is a block diagram illustrating a split centralized unit (CU)/distributed unit (DU) base station architecture that may be used in certain embodiments. In some wireless communication systems, a base station functionality may be split between CU and one or more DUs, where the CU acts control the one or more DUs and connect them back to the CN, while the one or more DUs act to provide physical level radio resources of the RAN as controlled by the CN. The control plane of the F1 (F1-C) interface allows signaling between the CU-C and DU, while the user plane of the F1 (F1-U) interface allows the transfer of application data.

### Multi-Group Transmission Request

In certain embodiments, a Tx PDCP entity sends a multi-group transmission (MGTx) request to one of the Tx RLC/MAC entities. The MGTx request may include, for example, a number of groups in the request, multiple groups of PDUs, an ID of the MGTx request, and a Tx configuration per each group. Multiple groups of PDUs transmitted in the MGTx request may be assumed to be disjoint as sets. In other words, a PDU can belong to not more than one group in MGTx request.

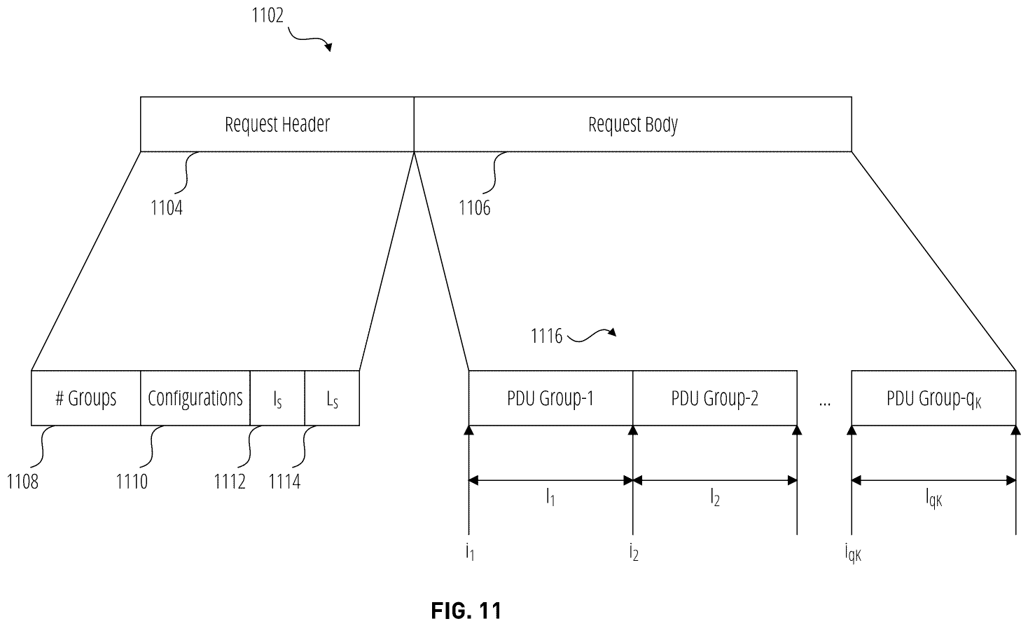

The MGTx request may be provided in the form of a request header and a request body. For example, FIG. 11 illustrates an MGTx request 1102, according to certain embodiments. The MGTx request 1102 includes a request header 1104 and a request body 1106.

The request header 1104 indicates number of groups 1108 in the MGTx request 1102, configurations 1110 for each group, an index 1112 of the first PDU corresponding to each group in the MGTx request 1102, and a number of PDUs 1114 corresponding to each group supported in the MGTx request 1102. The request body 1106 includes the PDU groups 1116. The index 1112 is shown as I_{S}=i₁, i₂, . . . , i_{qK}. The number of PDUs 1114 is shown as L_{S}=l₁, l₂, . . . , l_{qK}.

### RLC/MAC Functionality: Dynamic Discard

In certain embodiments, a Tx RLC entity (e.g., TM or UM RLC comprising a separate entity or integrated in a MAC entity) uses a dynamic discard procedure to let the PDCP layer have more dynamic control over the state of RLC/MAC. The dynamic discard procedure is based on a time-to-live (TTL) timer configured by a Tx PDCP entity. During the TTL time period, RLC SDU can be processed by the UM RLC as usual (i.e., TM RLC or a MAC entity implementing UM/TM RLC functionality). For example, the RLC SDU may be buffered, processed into one or several RLC PDU(s) (in general case, segmented), and allocated in one or many MAC hybrid automatic repeat request (HARQ) processes. If the TTL timer of an RLC SDU expires, the RLC/MAC entity discards the corresponding RLC SDU(s) using the RLC/MAC discard procedure.

The TTL timer can be configured for a group of RLC SDUs, a logical channel, a logical sub-channel of a logical channel. The TTL timer starts when an RLC SDU is obtained by a transmitter-side RLC entity (or MAC entity if RLC is integrated with MAC).

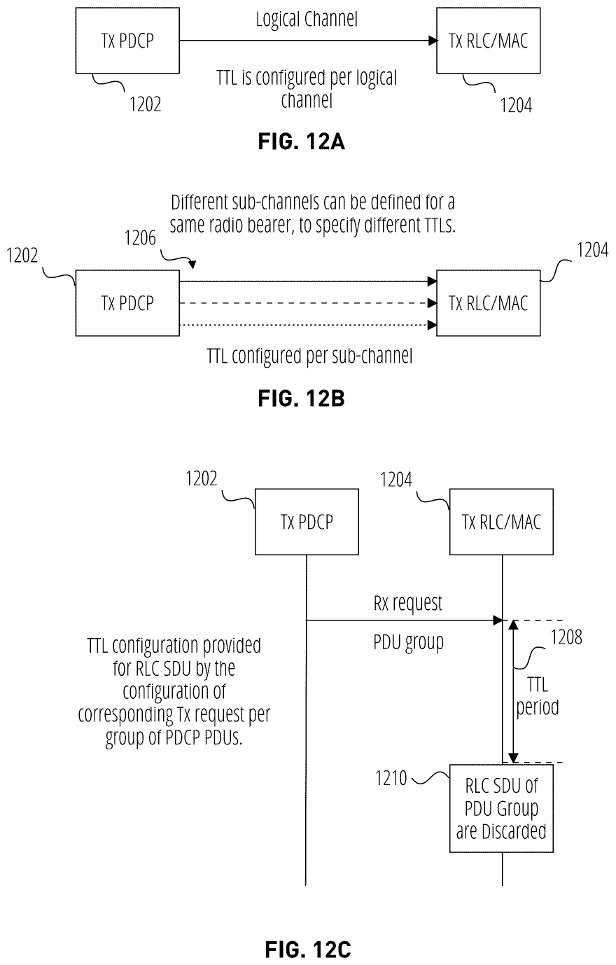

For example, FIG. 12A, FIG. 12B, and FIG. 12C illustrate different options for a Tx PDCP entity 1202 to configure a TTL timer for a Tx RLC/MAC entity 1204, according to certain embodiments. In the example of FIG. 12A, the Tx PDCP entity 1202 configures the TTL per logical channel.

In the example of FIG. 12B, different sub-channels 1206 (three shown) can be defined for a same radio bearer, to specify TTLs. Thus, the Tx PDCP entity 1202 may configure the TTL per sub-channel.

In the example of FIG. 12C, the Tx PDCP entity 1202 provides the TTL configuration for an RLC SDU by the configuration of a corresponding Tx request per PDU group (i.e., group of PDCP PDUs). After a receiving the Rx request, the Tx RLC/MAC entity 1204 waits a TTL period 1208 before performing the RLC/MAC discard procedure 1210 to discard the RLC SDU of the PDU group.

In certain embodiments, an RLC/MAC discard procedure for an RLC SDU includes: flushing the RLC SDU from the buffer; not allocating the related RLC PDUs in new HARQ processes; and reconsidering the decision about retransmissions of existing HARQ processes that include the related RLC PDUs. In certain such embodiments, if the receiver supports individual handling of code block groups (CBGs), the CBGs that contain only data of MAC SDUs corresponding to a discarded RLC SDU are not retransmitted. In addition, or in other embodiments, HARQ processes that include only the related RLC PDUs can be released.

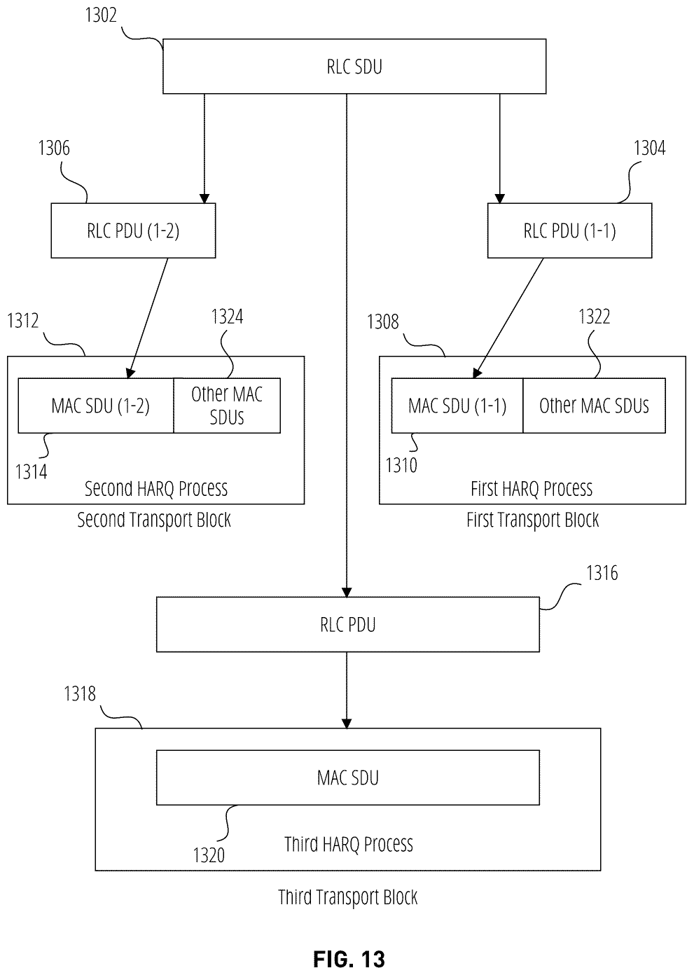

FIG. 13 is a flow diagram illustrating an example RLC TTL-based discard process, according to certain embodiments. The process may be performed by a UM/TM RLC entity. In this example, an RLC SDU 1302 is segmented, resulting in RLC PDU (1-1) 1304 and RLC PDU (1-2) 1306. The RLC PDU (1-1) 1304 is allocated in a first transport block 1308 associated with a HARQ process as MAC SDU (1-1) 1310. The RLC PDU (1-2) 1306 is allocated in a second transport block 1312 associated with a second HARQ process as a MAC SDU (1-2) 1314. In addition, in this example, the whole RLC SDU 1302, as an RLC PDU 1316, is allocated in a third transport block 1318 associated with a third HARQ process as a MAC SDU 1320.

When the TTL timer associated with the RLC SDU 1302 expires, the RLC SDU 1302 is flushed from the buffer, no more RLC PDUs are generated for new HARQ processes, and the first HARQ process continues retransmissions to deliver other MAC SDUs 1322. However, the CBGs that contain only the MAC SDU (1-1) 1310 are not retransmitted). Further, when the TTL timer expires, the second HARQ process stops retransmissions, releases the process, and puts other MAC SDUs 1324 to a new HARQ process. Also, when the TTL timer expires, the third HARQ Process stops retransmissions and releases the process.

### RLC/MAC Functionality: Delivery of Tx Report to PDCP

As discussed above, in response to a Tx request message, a Tx RLC/MAC entity of a wireless device determines one or more delivered PDUs and one or more non-delivered PDUs within a TTL period configured by Tx request configuration information and generates a delivery Tx report based on the one or more delivered PDUs and the one or more non-delivered PDUs. After expiration of a time-to-report (TTR) period configured by the Tx request configuration information, the Tx RLC/MAC entity sends the delivery Tx report to the Tx PDCP entity. In response to the delivery Tx report, the Tx PDCP entity determines whether or not to retransmit the one or more non-delivered PDUs.

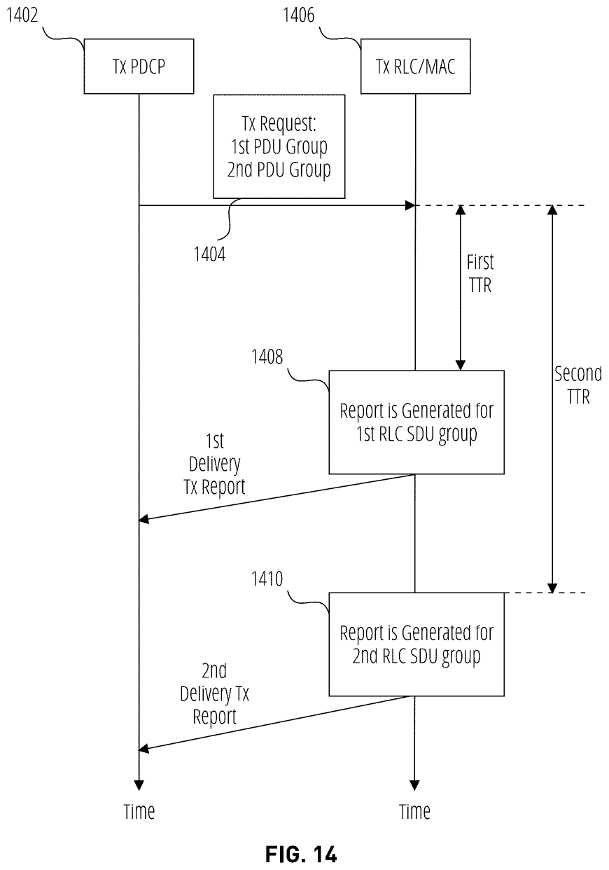

FIG. 14 is a signal diagram illustrating an example delivery Tx report, according to certain embodiments. In this example, a Tx PDCP entity 1402 sends a Tx request 1404 to a Tx RLC/MAC entity 1406 for a first PDU group and a second PDU group. The Tx request 1404 may configure TTR for a group of RLC SDUs, a logical channel, or a logical subchannel of a logical channel. Based on configuration information in the Tx request 1404, the Tx RLC/MAC entity 1406 may start a first TTR timer and a second TTR timer at the moment when RLC SDU is obtained by the transmitter-side RLC entity (or MAC entity if RLC is integrated with MAC). In other embodiments, the TTR timer is periodic and starts over expiration. In the illustrated example, when the first TTR timer expires, the Tx RLC/MAC entity 1406 generates 1408 a first delivery Tx report for a first RLC SDU group corresponding to the first PDU group, and sends the first delivery Tx report to the Tx PDCP entity 1402. Similarly, when the second TTR timer expires, the Tx RLC/MAC entity 1406 generates 1410 a second delivery Tx report for a second RLC SDU group corresponding to the second PDU group, and sends the second delivery Tx report to the Tx PDCP entity 1402.

The delivery Tx report (e.g., the first delivery Tx report and/or the second delivery Tx report) includes a Tx report ID and a PDU group ID. In certain embodiments, the delivery Tx report indicates “success” when all PDUs associated with the PDU group ID are delivered within the TTL period, “failure” when all the PDUs associated with the PDU group ID are not delivered within the TTL period, and “partial success” when one or more first PDUs associated with the PDU group ID are delivered within the TTL period and one or more second PDUs associated with the PDU group ID are not delivered within the TTL period. For example, the delivery Tx report may include one or more of a bitmap indicating the one or more delivered PDUs and the one or more non-delivered PDUs, a number of the one or more delivered PDUs, an index of a first of the one or more non-delivered PDUs or of a last of the one or more delivered PDUs, and indices of each of the one or more delivered PDUs or each of the one or more non-delivered PDUs.

### PDCP to RLC/MAC Protocol

In certain embodiments, when a TTL time period expires for a group of RLC SDUs and they are discarded at RLC/MAC, the corresponding delivery report is generated by the Tx RLC/MAC entity and is sent to the Tx PDCP entity. In addition, or in other embodiments, if a group of RLC SDUs is successfully delivered within the TTR time period, a “success” report is generated by Tx RLC (or Tx MAC) and is sent to the Tx PDCP entity.

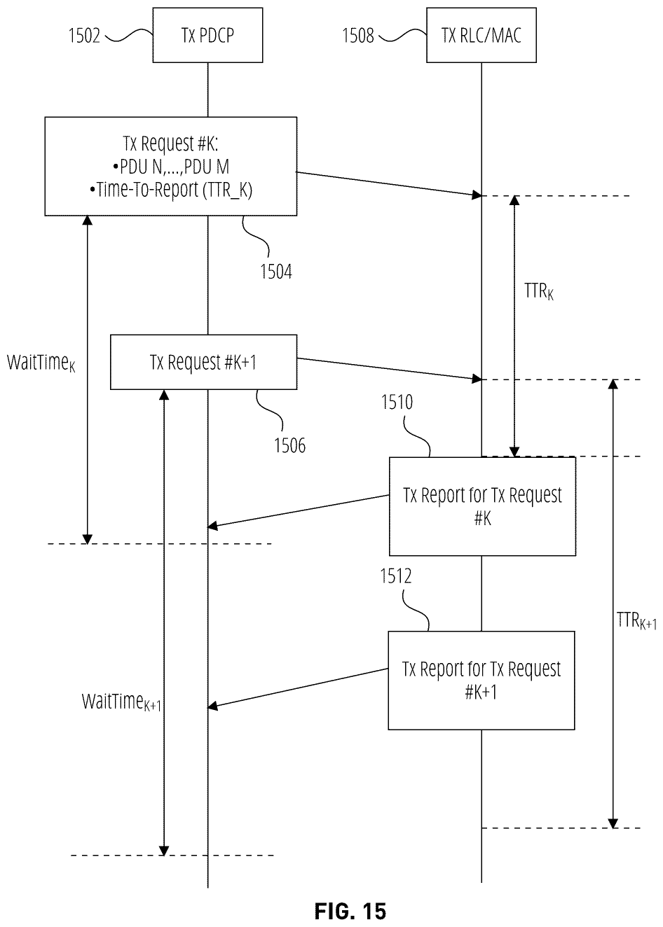

Further, in certain embodiments, the Tx PDCP entity can be configured with a wait timer to wait for the report for the request (e.g., WaitTime=TTR+Constant). If the wait timer is expired, all PDUs of the request are considered by the Tx PDCP entity as non-delivered in time. For example, FIG. 15 is a signal diagram illustrating use of a wait timer, according to certain embodiments. In this example, a Tx PDCP entity 1502 sends a first Tx request message 1504 with ID “K” (shown as Tx Request #K) and a second Tx request message 1506 with ID “K+1” (shown as Tx Request #K+1) to a TX RLC/MAC entity 1508. However, skilled persons will recognize from the disclosure herein that any number of Tx requests may be used.

The Tx request messages each include a respective ID (e.g., K, K+1, etc.) for the Tx request message, Tx request configuration information including respective TTR information (e.g., TTR period value), and one or more groups of PDUs (e.g., PDU N, . . . , PDU M). As discussed above, the Tx request configuration information also includes TTL information (e.g., TTL period value). In certain embodiments, a set of potential values of TTR and TTL can be pre-configured as a TTR_Set and a TTL_Set, respectively. In this case an index may be provided to indicate TTL (and/or TTR). In certain embodiments, the configured TTR period value does not exceed the TTL period value.

In the example shown in FIG. 15, the TX RLC/MAC entity 1508 starts a first TTR timer (TTR_{K}) upon receiving the first Tx request message 1504 from the Tx PDCP entity 1502 and generates a first delivery Tx report 1510 for the first Tx request message 1504 when the first TTR timer expires. The Tx PDCP entity 1502 is configured with a first wait timer (WaitTime_{K}), which is equal to the first TTR timer plus a predetermined value. If the Tx PDCP entity 1502 does not receive the first delivery Tx report 1510 when the first wait timer expires, the Tx PDCP entity 1502 considers all PDUs of the first Tx request message 1504 as non-delivered.

The TX RLC/MAC entity 1508 starts a second TTR timer (TTR_{K+1}) upon receiving the second Tx request message 1506 from the Tx PDCP entity 1502 and generates a second delivery Tx report 1512 for the second Tx request message 1506 when the second TTR timer expires. The Tx PDCP entity 1502 is configured with a second wait timer (WaitTime_{K+1}), which is equal to the second TTR timer plus a predetermined value. If the Tx PDCP entity 1502 does not receive the second delivery Tx report 1512 when the second wait timer expires, the Tx PDCP entity 1502 considers all PDUs of the second Tx request message 1506 as non-delivered.

### Control Messages from Tx PDCP to Tx RLC/MAC

In certain embodiments, a Tx PDCP entity is configured to send one or more control messages to a Tx RLC/MAC entity. For example, the Tx PDCP entity may send an update configuration message to the Tx RLC/MAC entity. The update configuration message includes a Tx request ID, (optionally) a PDU group ID, and a new (or partial) configuration. Upon reception, the RLC/MAC entity updates the configuration for RLC SDUs (e.g., TTL and TTR timers). New timers start upon reception of the message. If the PDU group ID is not specified, the configuration is applied to all PDU groups in the request. If the provided new configuration is partial, it overrides only the corresponding parts indicated.

As another example, the Tx PDCP entity may send a discard command for a Tx request message, which may include a Tx request ID and (optionally) a PDU group ID. Upon reception, the RLC/MAC entity discards the RLC SDUs of the indicated PDU group. If the PDU group ID is not specified, the discard command is applied to all PDU groups in the request.

In addition, or in other embodiments, the Tx PDCP entity may send a report command for a Tx request message, which may include a Tx request ID and (optionally) a PDU group ID. Upon reception, the RLC/MAC entity generates a Tx delivery report for the RLC SDUs of the indicated PDU group. If PDU group ID is not specified, the report command is applied to all PDU groups in the request.

### PDCP Functionality for Multi-Link Operation

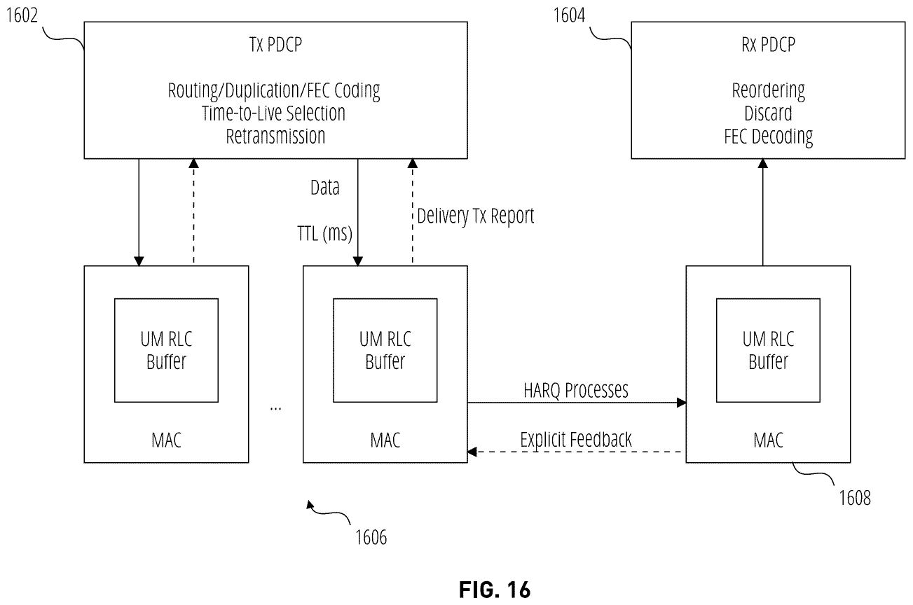

FIG. 16 is a block diagram illustrating PDCP functionality to support multi-link operation, according to certain embodiments. A wireless device may include, for example, a Tx PDCP entity 1602 and a Rx PDCP entity 1604. The Tx PDCP entity 1602 decides how to group PDUs and how to select a TTL period [e.g., in milliseconds (ms)]. In certain embodiments, the Tx PDCP entity 1602 may optionally use quality of service (QoS) delay budget information when it selects a TTL period. If PDU Set information is available at the Tx PDCP entity 1602, the Tx PDCP entity 1602 may optionally use it when grouping PDUs.

If the Tx PDCP entity 1602 is configured with multiple RLCs/MACs 1606, the Tx PDCP entity 1602 may select one or several of them to route the group of PDUs. If more than one RLCs/MACs 1606 are selected, the group of PDUs can be duplicated or (if supported by the receiver) redundant packets can be added with forward error correction (FEC) packet coding.

The receiver-side PDCP, or reception PDCP (Rx PDCP entity 1604) implements reordering functionality, duplication discard, and (optionally) decoding for FEC packet coding. The Rx PDCP entity 1604 may be configured with an RLC/MAC 1608 that interfaces with the RLCs/MACs 1606 to handle HARQ processes and provide explicit feedback (e.g., the delivery Tx report).

After receiving the delivery Tx report for the Tx request message, as discussed above, the Tx PDCP entity 1602 removes the delivered PDUs from its buffer. It can handle the non-delivered PDUs in the same manner as any other PDUs in the buffer (e.g., deciding to transmit them again).

### Example PDCP Behavior: Smart Duplication

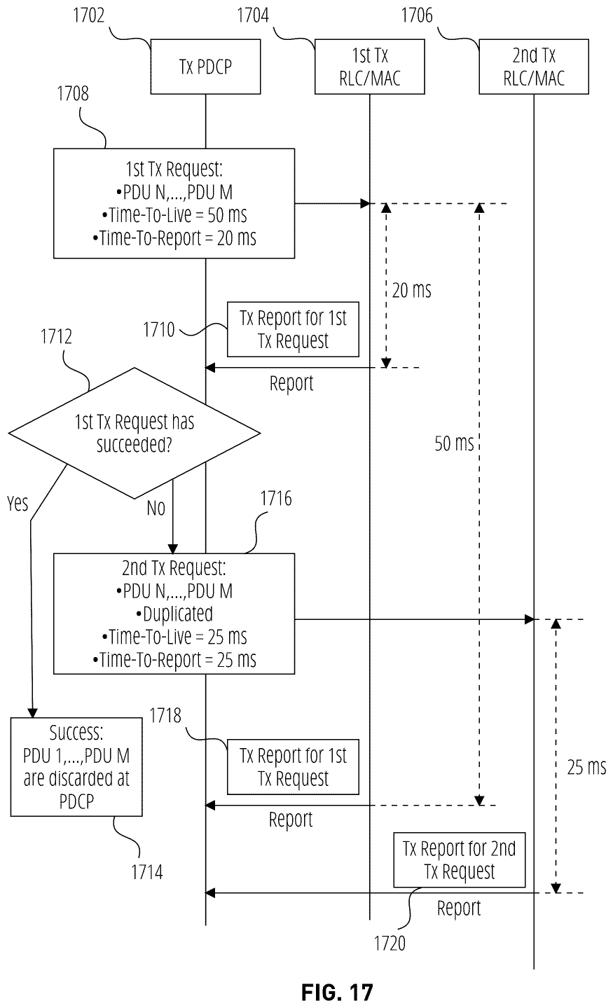

In certain embodiments, PDCP SDUs can be configured with a delay budget (e.g., the same as a PDCP discard timer). For example, FIG. 17 is a signal diagram illustrating smart duplication, according to certain embodiments. In this example, a Tx PDCP entity 1702 is configured with a first Tx RLC/MAC entity 1704 and a second Tx RLC/MAC entity 1706. In the example shown in FIG. 17, the TTL of a PDCP PDU is a discard timer for RLC/MAC layers and can be less than or equal to the PDCP SDU delay budget. For example, The TTL period can be a fraction of PDCP delay budget.

The Tx PDCP entity 1702 sends a first Tx request 1708 to the first Tx RLC/MAC entity 1704 including a group of PDUs (PDU N, . . . , PDU M), a TTL period of 50 ms, and a TTR period of 20 ms. In this example, the delay budget for PDCP SDUs delivery is 50 ms. Based on a Tx delivery report 1710 from the first Tx RLC/MAC entity 1704, the Tx PDCP entity 1702 determines 1712 whether the first Tx request 1708 has succeeded. If yes, the Tx PDCP entity 1702 handles the success 1714 by discarding the group of PDUs in its buffer.

If no, i.e., the Tx delivery report 1710 for the first Tx request 1708 is negative after 20 ms, the Tx PDCP entity 1702 sends non-transmitted data to the second Tx RLC/MAC entity 1706 in a second Tx request 1716 by doing duplication. In the second Tx request 1716, in this example, the Tx PDCP entity 1702 configures the TTL period=TTR period=25 ms (i.e., a remaining time budget of 25 ms is based on 50 ms−20 ms−25 ms=5 ms for overhead). The Tx PDCP entity 1702 receives a Tx delivery report 1718 from the first Tx RLC/MAC entity 1704 based on the TTL=50 ms of the first Tx request 1708 and receives a Tx delivery report 1720 from the second Tx RLC/MAC entity 1706 based on the TTL=25 ms of the second Tx request 1716.

Delaying the duplication until it is needed increases reliability due to multi-link diversity with less resource consumption compared with duplication in other wireless systems (i.e., the duplication is done only if the first attempt fails).

### Example PDCP Behavior: Duplication with Discard

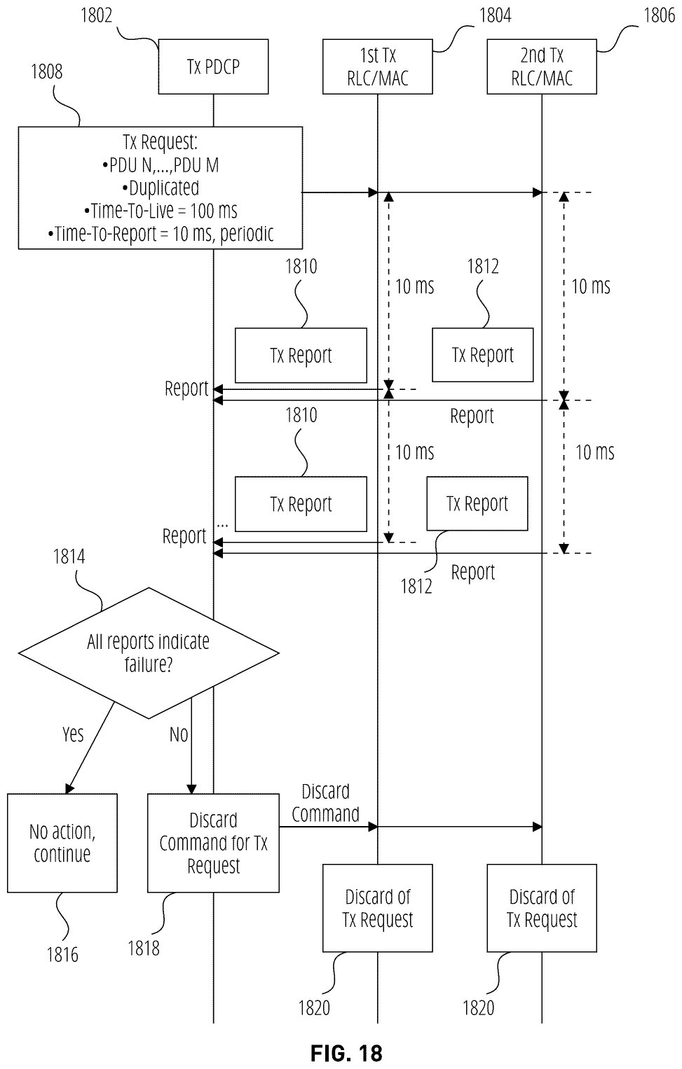

In certain embodiments, a discard command for a Tx request is helpful in case of data duplication. For example, FIG. 18 is a signal diagram illustrating duplication with discard, according to certain embodiments. As shown, a Tx PDCP entity 1802 is configured with a first Tx RLC/MAC entity 1804 and a second Tx RLC/MAC 1806. In the example illustrated in FIG. 18, a delay budget for PDCP SDUs is 100 ms and a packet group is considered to have a high value intended to be reliably delivered.

The Tx PDCP entity 1802 sends a Tx request 1808 to the first Tx RLC/MAC entity 1804 and the second Tx RLC/MAC 1806 using duplication of a group of PDUs (PDU N, . . . , PDU M). The Tx request 1808 indicates a TTL period of 100 ms and a periodic TTR period of 10 ms. Thus, the first Tx RLC/MAC entity 1804 sends Tx delivery reports 1810 and the second Tx RLC/MAC 1806 sends Tx delivery reports 1812 every 10 ms. Based on the reports, the Tx PDCP entity 1802 determines 1814 whether all the reports indicate failure. If yes, the Tx PDCP entity 1802 takes no action (does not send a discard command) and continues 1816 with the PDCP retransmission process. If no, i.e., some link indicates “success” of the delivery of the group of PDUs in the Tx request 1808, the Tx PDCP entity 1802 sends a discard command 1818 for the Tx request 1808 to the first Tx RLC/MAC entity 1804 and the second Tx RLC/MAC 1806. In response, the first Tx RLC/MAC entity 1804 and the second Tx RLC/MAC 1806 discard 1820 the Tx request 1808. Thus, the example shown in FIG. 18 provides reliability due to packet duplication, while also providing less resource consumption compared with that of other wireless systems because, if the data is delivered, the delivered data is discarded from all links.

### Example PDCP Behavior: Link Switch

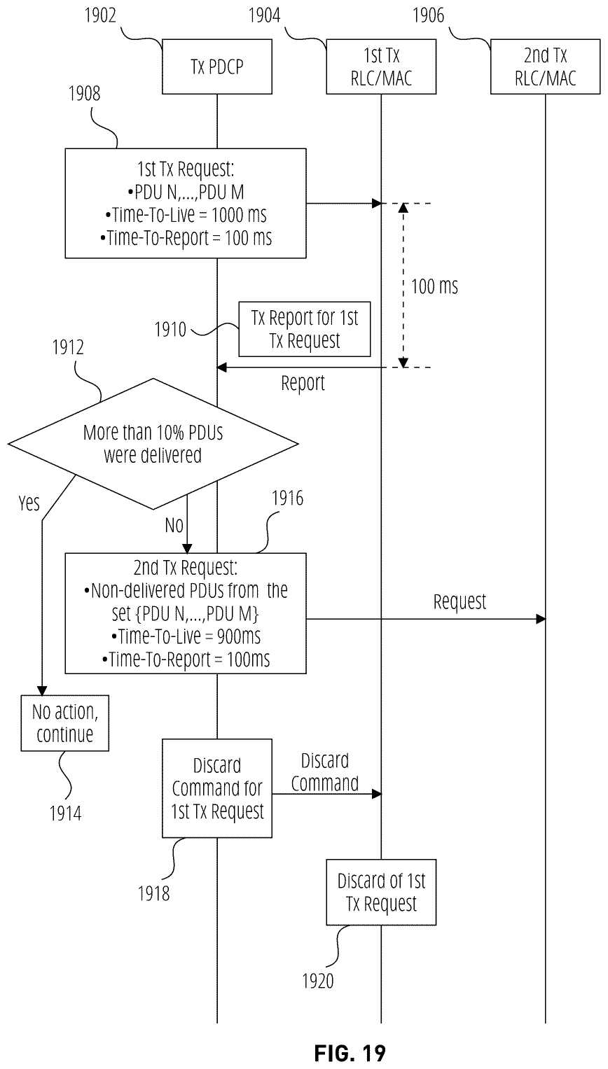

In certain embodiments, a detailed delivery report can assist the decision to switch the link. For example, FIG. 19 is a signal diagram illustrating link switching, according to certain embodiments. As shown, a Tx PDCP entity 1902 is configured with a first Tx RLC/MAC entity 1904 and a second Tx RLC/MAC second Tx RLC/MAC entity 1906. In the example illustrated in FIG. 19, a delay budget for PDCP SDUs delivery is 100 ms.

The Tx PDCP entity 1902 sends a first Tx request 1908 to the first Tx RLC/MAC entity 1904 including a group of PDUs (PDU N, . . . , PDU M), a TTR period of 100 ms, and a TTL period of 1000 ms. Based on a Tx delivery report 1910 for the first Tx request 1908, the Tx PDCP entity 1902 determines 1912 whether more than a configured threshold (e.g., 10%) of the PDUs in the first Tx request 1908 were delivered. If yes, the Tx PDCP entity 1902 takes no action (does not send a discard command) and continues 1914 with the PDCP retransmission process.

If no, i.e., after 100 ms the number of delivered packets is less than the configured threshold (e.g., 10%), the Tx PDCP entity 1902 switches the link by sending a second Tx request 1916 to the second Tx RLC/MAC entity 1906 and a discard command 1918 for the first Tx request 1908 to the first Tx RLC/MAC entity 1904. The second Tx request 1916 includes the non-delivered PDUs from the first Tx request 1908 (i.e., non-delivered PDUs from the set {PDU N, . . . , PDU M}). In the example shown in FIG. 19, the Tx PDCP entity 1902 configures the TTL period to 900 ms and the TTR period to 100 ms in the second Tx request 1916.

The first Tx RLC/MAC entity 1904 discards 1920 the first Tx request 1908 while the second Tx RLC/MAC entity 1906 processes the second Tx request 1916. Thus, the example solution shown in FIG. 19 provides resilience in that, if the first link is broken, the transmission is switched to the second link. The example solution also provides delivery speed up in that, if the first link is slow, the transmission is switched to the second link. The example solution also provides a reduced or negligible overhead in radio resource consumption compared with a single link approach.

### Time-To-Live Aware MAC PDU Allocation

In certain MAC PDU structures (e.g., the MAC PDU structure adopted in 5G systems), the location of each next MAC SDU sub-header is provided in the previous sub-header. Thus, when a sub-header is not decoded, all the subsequent MAC SDUs are not decoded as well. In such systems, the probability of decoding the MAC SDUs allocated first is higher than the probability of decoding the MAC SDUs allocated later.

Thus, certain embodiments disclosed herein for allocation of MAC SDUs of the same logical channel include allocating the MAC SDUs in an increasing order of remaining TTL time budget. If retransmission is done based on CBGs, certain embodiments allocate to CBG MAC SDUs of the same remaining TTL time budget. In this case, if the time budget expires and MAC SDUs are not to be retransmitted, the whole CBG can be skipped in retransmission.

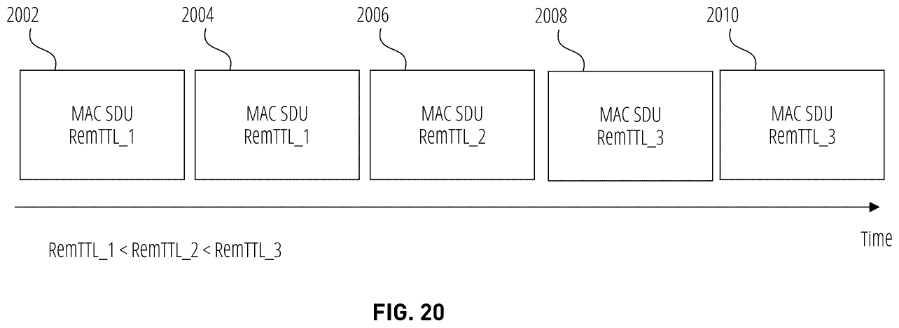

In certain embodiments, if MAC can initiate several HARQ processes with the UE, the MAC can allocate MAC SDUs with the same remaining TTL time budget in the same transport block. For example, FIG. 20 is a block diagram illustrating MAC PDU allocation of MAC SDUs from the same logical channel but with various remaining TTL time budgets (RemTTLs), according to certain embodiments. In this example, a first MAC SDU 2002 and a second MAC SDU 2004 have a first remaining TTL time budget (RemTTL_1), a third MAC SDU 2006 has a second remaining TTL time budget (RemTTL_2), and a fourth MAC SDU 2008 and a fifth MAC SDU 2010 have a third remaining TTL time budget (RemTTL_3), where RemTTL_1<RemTTL_2<RemTTL_3. Based on the RemTTLs, the first MAC SDU 2002 and second MAC SDU 2004 may be allocated in a first transport block, followed by the third MAC SDU 2006 allocated in a second transport block, followed by the fourth MAC SDU 2008 and fifth MAC SDU 2010 allocated in a third transport block.

### Reassembly Timer Configuration

In certain embodiments, a t-Reassembly timer at the receiver to release the reassembly process is configured to match the TTL timer at the transmitter to timely release the receiver resources. In certain such embodiments, if the TTL timer is configured per group of PDUs via request-based signaling embodiments disclosed herein, the t-Reassembly timer may be provided per RLC SDU and may be indicated in the RLC header or in the MAC sub-header of the corresponding MAC SDUs. Table 1 provides different options, according to certain embodiments herein, for combinations of TTL timer and t-Reassembly timer configurations.

TABLE 1

| | | Configuration | Granularity | Configuration |
|---|---|---|---|---|
| | Granularity | mechanism | of t- | mechanism for |
| | of Time-To- | for Tx Time- | Reassembly | Rx t- |
| | Live Timer | To-Live | Timer | Reassembly |
| Options | configuration | Timer | configuration | Timer |
| Option 1 | Logical | RRC | Logical | RRC |
| | Channel | | Channel | |
| Option 2 | Logical Sub- | RRC | Logical Sub- | RRC |
| | Channel | | Channel | |
| Option 3 | Group of | PDCP-to- | Logical | RRC |
| | PDUs | RLC/MAC | Channel | |
| Option 4 | | Request | Logical Sub- | RRC |
| | | signaling | Channel | |
| Option 5 | | | RLC SDU | Included in |
| | | | | RLC header |
| | | | | or MAC sub- |
| | | | | header |

### Example PDCP Retransmission for Cell-Free Connectivity

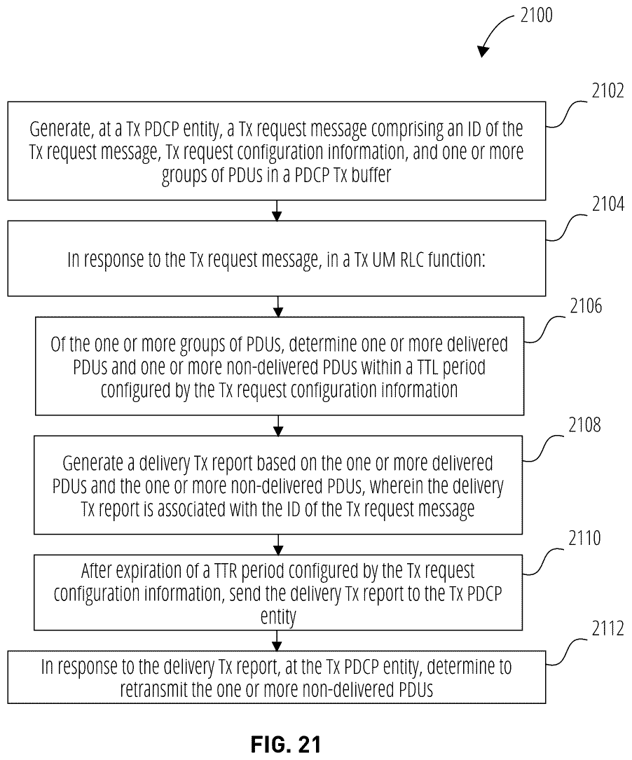

FIG. 21 is a flowchart of a method 2100 for PDCP retransmission for cell-free connectivity of a wireless device, according to certain embodiments. In block 2102, the method 2100 includes generating, at a Tx PDCP entity of the wireless device, a Tx request message including an ID of the Tx request message, Tx request configuration information, and one or more groups of PDUs in a PDCP Tx buffer of the wireless device.

In block 2104, in response to the Tx request message, in a Tx UM RLC function of the wireless device, the method 2100 includes performing block 2106, block 2108, and block 2110. In block 2106, of the one or more groups of PDUs, the method 2100 includes determining one or more delivered PDUs and one or more non-delivered PDUs within a TTL period configured by the Tx request configuration information. In block 2108, the method 2100 includes generating a delivery Tx report based on the one or more delivered PDUs and the one or more non-delivered PDUs. The delivery Tx report is associated with the ID of the Tx request message. In block 2110, after expiration of a TTR period configured by the Tx request configuration information, the method 2100 includes sending the delivery Tx report to the Tx PDCP entity.

In block 2112, in response to the delivery Tx report, at the Tx PDCP entity, the method 2100 includes determining to retransmit the one or more non-delivered PDUs.

In certain embodiments of the method 2100, the Tx UM RLC function is implemented in one or more of a Tx RLC entity and a media access control (MAC) entity.

In certain embodiments of the method 2100, the Tx request message includes a multi-group Tx request message comprising: a request header including a number groups of the one or more groups of PDUs in the multi-group Tx request message, a respective Tx configuration for each of the one or more groups of PDUs in the multi-group Tx request message, an index value of a first PDU in each of the one or more groups of PDUs in the multi-group Tx request message, and a number of PDUs in each of the one or more groups of PDUs in the multi-group Tx request message; and a request body comprising the one or more groups of PDUs arranged as indicated in the request header.

In certain embodiments, the method 2100 further includes, at the Tx UM RLC function: starting a TTL timer corresponding to the TTL period configured by the Tx request configuration information upon receiving the Tx request message at the Tx UM RLC function from the Tx PDCP entity; during the TTL period, processing RLC service data units (SDUs) corresponding to the one or more groups of PDUs; and when the TTL timer expires, discarding one or more of the RLC SDUs associated with the TTL timer. In certain such embodiments, the TTL timer is configured for one of a group of RLC SDUs, a logical channel, or a logical sub-channel of the logical channel. In addition, or in other embodiments, processing the RLC SDUs during the TTL period comprises one or more of buffering the RLC SDUs, segmenting the RLC SDUs, and allocating the RLC SDUs into one or more media access control (MAC) hybrid automatic repeat request (HARQ) processes; and discarding the one or more of the RLC SDUs comprises performing a discard procedure including: flushing related RLC SDUs from a buffer; determining to not allocate the related RLC SDUs to new HARQ processes; determining whether or not to perform retransmissions associated with existing HARQ processes that include the related RLC SDUs; releasing the HARQ processes that include only the related RLC SDUs; and determining not to retransmit any code block groups (CBGs) containing only data of MAC SDUs corresponding to a discarded RLC SDU.

In certain embodiments, the method 2100 further includes, at the Tx UM RLC function: starting a TTR timer corresponding to the TTR period configured by the Tx request configuration information upon receiving the Tx request message at the Tx UM RLC function from the Tx PDCP entity; and when the TTR timer expires, generating the delivery Tx report comprising a Tx report ID, a PDU group ID, and an indication selected from a group comprising: a success indication when all PDUs associated with the PDU group ID are delivered within the TTL period; a failure indication when all the PDUs associated with the PDU group ID are not delivered within the TTL period; and a partial success indication when one or more first PDUs associated with the PDU group ID are delivered within the TTL period and one or more second PDUs associated with the PDU group ID are not delivered within the TTL period. In certain embodiments, the TTR timer is configured for one of a group of RLC service data units (SDUs), a logical channel, or a logical sub-channel of the logical channel. In certain embodiments, the TTR timer is periodic such that when it expires for a first PDU group ID it starts over for a second PDU group ID. In certain embodiments, the delivery Tx report comprises one or more of: a bitmap indicating the one or more delivered PDUs and the one or more non-delivered PDUs; a number of the one or more delivered PDUs; an index of a first of the one or more non-delivered PDUs or of a last of the one or more delivered PDUs; and indices of each of the one or more delivered PDUs or each of the one or more non-delivered PDUs.

In certain embodiments, the method 2100 further includes generating, at the Tx PDCP entity for delivery to the Tx UM RLC function, one or more of: an update configuration message to update or modify the Tx request configuration information; a discard command message for the Tx UM RLC function to discard an indicated PDU group or each of the one or more groups of PDUs in the Tx request message; and a report command message for the Tx UM RLC function to generate the delivery Tx report for the indicated PDU group or each of the one or more groups of PDUs in the Tx request message.

In certain embodiments, the method 2100 further includes, at the Tx PDCP entity: grouping a plurality of PDUs in the PDCP Tx buffer into the one or more groups of PDUs; and selecting the TTL period for the one or more groups of PDUs. In certain embodiments, the method further includes, at the Tx PDCP entity, selecting the TTL period based on quality of service (QoS) delay budget information. In certain embodiments, the method further includes, at the Tx PDCP entity, grouping the plurality of PDUs based on PDU set information available at the Tx PDCP entity.

In certain embodiments of the method 2100, the Tx PDCP entity is configured with multiple RLC entities or media access control (MAC) entities implementing the Tx UM RLC function, and the method 2100 further includes selecting, at the Tx PDCP entity, one or more of the multiple RLC entities or MAC entities for routing the one or more groups of PDUs. In certain such embodiments, when a plurality of the multiple RLC entities or MAC entities are selected by the Tx PDCP entity for routing the one or more groups of PDUs, the method further includes duplicating the one or more groups of PDUs or adding redundant packets with forward error correction (FEC) packet coding.

In certain embodiments, the method 2100 further includes performing, at a reception (Rx) PDCP entity, one or more of PDU reordering, PDU duplication discard, and decoding for forward error correction (FEC) packet coding. In addition, or in other embodiments, the method includes, in response to receiving the Tx delivery report at the Tx PDCP entity, removing the one or more delivered PDUs from the PDCP Tx buffer, wherein determining to retransmit the one or more non-delivered PDUs comprises handling the one or more non-delivered PDUs along with other PDUs remaining in the PDCP Tx buffer.

In certain embodiments, the method 2100 further includes: configuring PDCP service data units (SDUs) with a delay budget, wherein the TTL period is less than or equal to the delay budget, and wherein the TTR period is less than the TTL period; and when the delivery Tx report indicates the one or more non-delivered PDUs are not delivered by a first RLC layer or first media access control (MAC) layer implementing the Tx UM RLC function, sending the one or more non-delivered PDUs by duplication from the Tx PDCP entity to a second RLC layer or MAC layer implementing the Tx UM RLC function. In certain such embodiments, the method further includes sending a discard command message from the Tx PDCP entity to the first RLC layer or first MAC layer to discard the Tx request message.

In certain embodiments, the method 2100 further includes sending a discard command message to discard PDCP duplicated packets in response to the delivery Tx reporting indicating a successful delivery of the one or more delivered PDUs.

In certain embodiments, the method 2100 further includes allocating media access control (MAC) service data units (SDUs) of a same logical channel in an increasing order based on a remaining TTL time budget.

In certain embodiments of the method 2100, retransmission is based on code block groups (CBGs), and the method further includes: allocating media access control (MAC) service data units (SDUs) of a same CBG based on a remaining TTL time budget; and skipping the MAC SDUs of the same CBG when the remaining TTL time budget expires.

In certain embodiments of the method 2100, a media access control (MAC) entity is configured to initiate a plurality of hybrid automatic repeat request (HARQ) processes, and the method further includes allocating MAC service data units (SDUs) of a same remaining TTL time budget in a same transport block.

In certain embodiments of the method 2100, the TTL period is configured per group of PDUs by the Tx request configuration information, wherein a t-reassembly timer is configured per RLC service data unit (SDU) at a receiving entity and indicated in an RLC header or a media access control (MAC) sub-header of corresponding MAC SDUs.

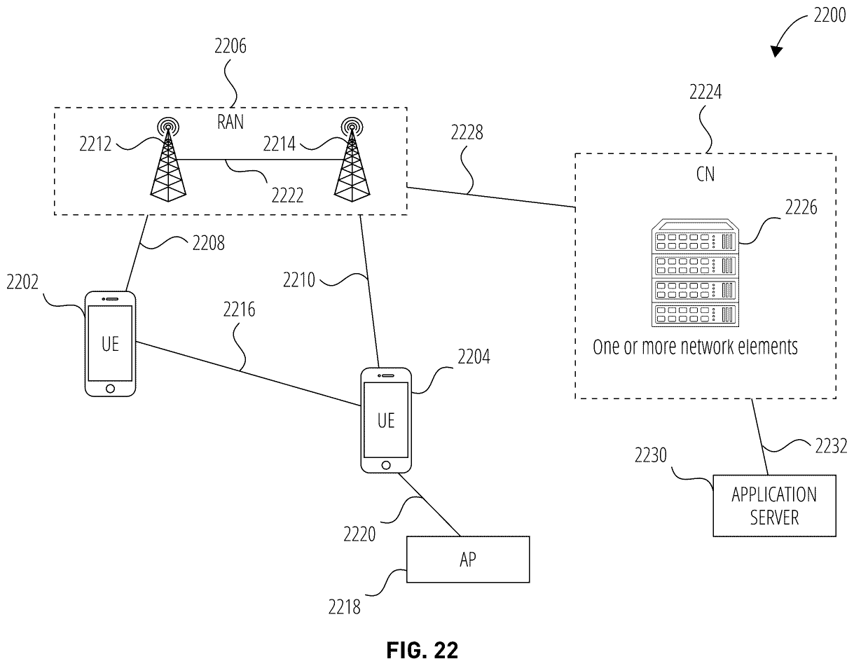

FIG. 22 illustrates an example architecture of a wireless communication system 2200, according to embodiments disclosed herein. The following description is provided for an example wireless communication system 2200 that operates in conjunction with the LTE system standards and/or 5G or NR system standards as provided by 3GPP technical specifications.

As shown by FIG. 22, the wireless communication system 2200 includes UE 2202 and UE 2204 (although any number of UEs may be used). In this example, the UE 2202 and the UE 2204 are illustrated as smartphones (e.g., handheld touchscreen mobile computing devices connectable to one or more cellular networks), but may also comprise any mobile or non-mobile computing device configured for wireless communication.

The UE 2202 and UE 2204 may be configured to communicatively couple with a RAN 2206. In embodiments, the RAN 2206 may be NG-RAN, E-UTRAN, etc. The UE 2202 and UE 2204 utilize connections (or channels) (shown as connection 2208 and connection 2210, respectively) with the RAN 2206, each of which comprises a physical communications interface. The RAN 2206 can include one or more base stations (such as base station 2212 and base station 2214) that enable the connection 2208 and connection 2210.

In this example, the connection 2208 and connection 2210 are air interfaces to enable such communicative coupling, and may be consistent with RAT(s) used by the RAN 2206, such as, for example, an LTE and/or NR.

In some embodiments, the UE 2202 and UE 2204 may also directly exchange communication data via a sidelink interface 2216. The UE 2204 is shown to be configured to access an access point (shown as AP 2218) via connection 2220. By way of example, the connection 2220 can comprise a local wireless connection, such as a connection consistent with any IEEE 802.11 protocol, wherein the AP 2218 may comprise a Wi-Fi® router. In this example, the AP 2218 may be connected to another network (for example, the Internet) without going through a CN 2224.

In embodiments, the UE 2202 and UE 2204 can be configured to communicate using orthogonal frequency division multiplexing (OFDM) communication signals with each other or with the base station 2212 and/or the base station 2214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2212 or base station 2214 may be implemented as one or more software entities running on server computers as part of a virtual network. In addition, or in other embodiments, the base station 2212 or base station 2214 may be configured to communicate with one another via interface 2222. In embodiments where the wireless communication system 2200 is an LTE system (e.g., when the CN 2224 is an EPC), the interface 2222 may be an X2 interface. The X2 interface may be defined between two or more base stations (e.g., two or more eNBs and the like) that connect to an EPC, and/or between two eNBs connecting to the EPC. In embodiments where the wireless communication system 2200 is an NR system (e.g., when CN 2224 is a 5GC), the interface 2222 may be an Xn interface. The Xn interface is defined between two or more base stations (e.g., two or more gNBs and the like) that connect to 5GC, between a base station 2212 (e.g., a gNB) connecting to 5GC and an eNB, and/or between two eNBs connecting to 5GC (e.g., CN 2224).

The RAN 2206 is shown to be communicatively coupled to the CN 2224. The CN 2224 may comprise one or more network elements 2226, which are configured to offer various data and telecommunications services to customers/subscribers (e.g., users of UE 2202 and UE 2204) who are connected to the CN 2224 via the RAN 2206. The components of the CN 2224 may be implemented in one physical device or separate physical devices including components to read and execute instructions from a machine-readable or computer-readable medium (e.g., a non-transitory machine-readable storage medium).

In embodiments, the CN 2224 may be an EPC, and the RAN 2206 may be connected with the CN 2224 via an S1 interface 2228. In embodiments, the S1 interface 2228 may be split into two parts, an S1 user plane (S1-U) interface, which carries traffic data between the base station 2212 or base station 2214 and a serving gateway (S-GW), and the S1-MME interface, which is a signaling interface between the base station 2212 or base station 2214 and mobility management entities (MMEs).

In embodiments, the CN 2224 may be a 5GC, and the RAN 2206 may be connected with the CN 2224 via an NG interface 2228. In embodiments, the NG interface 2228 may be split into two parts, an NG user plane (NG-U) interface, which carries traffic data between the base station 2212 or base station 2214 and a user plane function (UPF), and the S1 control plane (NG-C) interface, which is a signaling interface between the base station 2212 or base station 2214 and access and mobility management functions (AMFs).

Generally, an application server 2230 may be an element offering applications that use internet protocol (IP) bearer resources with the CN 2224 (e.g., packet switched data services). The application server 2230 can also be configured to support one or more communication services (e.g., VoIP sessions, group communication sessions, etc.) for the UE 2202 and UE 2204 via the CN 2224. The application server 2230 may communicate with the CN 2224 through an IP communications interface 2232.

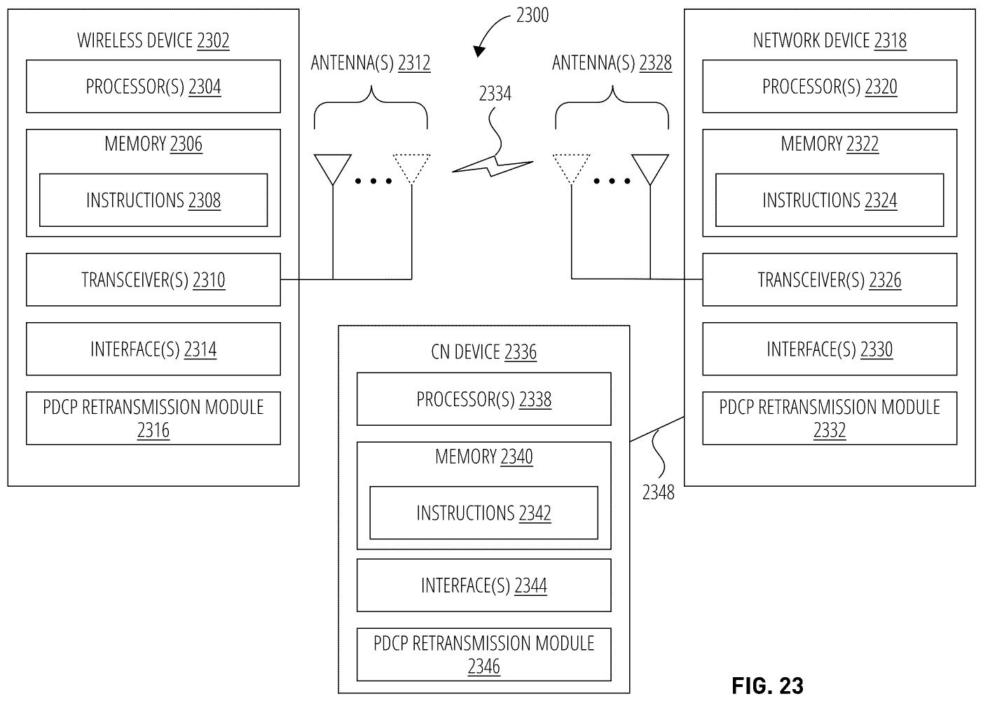

FIG. 23 illustrates a system 2300 for performing signaling 2334 between a wireless device 2302 and a network device 2318 as supported by a CN device 2336, according to embodiments disclosed herein. The system 2300 may be a portion of a wireless communications system as herein described. The wireless device 2302 may be, for example, a UE of a wireless communication system. The network device 2318 may be, for example, a base station (e.g., an eNB, a gNB, or a sixth generation base station) of a wireless communication system.

The wireless device 2302 may include one or more processor(s) 2304. The processor(s) 2304 may execute instructions such that various operations of the wireless device 2302 are performed, as described herein. The processor(s) 2304 may include one or more baseband processors implemented using, for example, a CPU, a digital signal processor (DSP), an application specific integrated circuit (ASIC), a controller, a field programmable gate array (FPGA) device, another hardware device, a firmware device, or any combination thereof configured to perform the operations described herein.

The wireless device 2302 may include a memory 2306. The memory 2306 may be a non-transitory computer-readable storage medium that stores instructions 2308 (which may include, for example, the instructions being executed by the processor(s) 2304). The instructions 2308 may also be referred to as program code or a computer program. The memory 2306 may also store data used by, and results computed by, the processor(s) 2304.

The wireless device 2302 may include one or more transceiver(s) 2310 that may include radio frequency (RF) transmitter circuitry and/or receiver circuitry that use the antenna(s) 2312 of the wireless device 2302 to facilitate signaling (e.g., the signaling 2334) to and/or from the wireless device 2302 with other devices (e.g., the network device 2318) according to corresponding RATs.

The wireless device 2302 may include one or more antenna(s) 2312 (e.g., one, two, four, or more). For embodiments with multiple antenna(s) 2312, the wireless device 2302 may leverage the spatial diversity of such multiple antenna(s) 2312 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 2302 may be accomplished according to precoding (or digital beamforming) that is applied at the wireless device 2302 that multiplexes the data streams across the antenna(s) 2312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2302 may implement analog beamforming techniques, whereby phases of the signals sent by the antenna(s) 2312 are relatively adjusted such that the (joint) transmission of the antenna(s) 2312 can be directed (this is sometimes referred to as beam steering).

The wireless device 2302 may include one or more interface(s) 2314. The interface(s) 2314 may be used to provide input to or output from the wireless device 2302. For example, a wireless device 2302 that is a UE may include interface(s) 2314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2310/antenna(s) 2312 already described) that allow for communication between the UE and other devices and may operate according to known protocols (e.g., Wi-Fi®, Bluetooth®, and the like).

The wireless device 2302 may include a PDCP retransmission module 2316. The PDCP retransmission module 2316 may be implemented via hardware, software, or combinations thereof. For example, the PDCP retransmission module 2316 may be implemented as a processor, circuit, and/or instructions 2308 stored in the memory 2306 and executed by the processor(s) 2304. In some examples, the PDCP retransmission module 2316 may be integrated within the processor(s) 2304 and/or the transceiver(s) 2310. For example, the PDCP retransmission module 2316 may be implemented by a combination of software components (e.g., executed by a DSP or a general processor) and hardware components (e.g., logic gates and circuitry) within the processor(s) 2304 or the transceiver(s) 2310.

The PDCP retransmission module 2316 may be used for various aspects of the present disclosure, for example, aspects of FIG. 7 to FIG. 21.

The network device 2318 may include one or more processor(s) 2320. The processor(s) 2320 may execute instructions such that various operations of the network device 2318 are performed, as described herein. The processor(s) 2320 may include one or more baseband processors implemented using, for example, a CPU, a DSP, an ASIC, a controller, an FPGA device, another hardware device, a firmware device, or any combination thereof configured to perform the operations described herein.

The network device 2318 may include a memory 2322. The memory 2322 may be a non-transitory computer-readable storage medium that stores instructions 2324 (which may include, for example, the instructions being executed by the processor(s) 2320). The instructions 2324 may also be referred to as program code or a computer program. The memory 2322 may also store data used by, and results computed by, the processor(s) 2320.

The network device 2318 may include one or more transceiver(s) 2326 that may include RF transmitter circuitry and/or receiver circuitry that use the antenna(s) 2328 of the network device 2318 to facilitate signaling (e.g., the signaling 2334) to and/or from the network device 2318 with other devices (e.g., the wireless device 2302) according to corresponding RATs.

The network device 2318 may include one or more antenna(s) 2328 (e.g., one, two, four, or more). In embodiments having multiple antenna(s) 2328, the network device 2318 may perform MIMO, digital beamforming, analog beamforming, beam steering, etc., as has been described.

The network device 2318 may include one or more interface(s) 2330. The interface(s) 2330 may be used to provide input to or output from the network device 2318. For example, a network device 2318 that is a base station may include interface(s) 2330 made up of transmitters, receivers, and other circuitry (e.g., other than the transceiver(s) 2326/antenna(s) 2328 already described) that enables the base station to communicate with other equipment in a core network, and/or that enables the base station to communicate with external networks, computers, databases, and the like for purposes of operations, administration, and maintenance of the base station or other equipment operably connected thereto. As another example, the network device 2318 may communicate with the CN device 2336 on an interface 2348 of the interface(s) 2330 (which, in, for example, NR cases may be an NG interface or in LTE cases may be an S1 interface).

The network device 2318 may include a PDCP retransmission module 2332. The PDCP retransmission module 2332 may be implemented via hardware, software, or combinations thereof. For example, the PDCP retransmission module 2332 may be implemented as a processor, circuit, and/or instructions 2324 stored in the memory 2322 and executed by the processor(s) 2320. In some examples, the PDCP retransmission module 2332 may be integrated within the processor(s) 2320 and/or the transceiver(s) 2326. For example, the PDCP retransmission module 2332 may be implemented by a combination of software components (e.g., executed by a DSP or a general processor) and hardware components (e.g., logic gates and circuitry) within the processor(s) 2320 or the transceiver(s) 2326.

The PDCP retransmission module 2332 may be used for various aspects of the present disclosure, for example, aspects of FIG. 7 to FIG. 21.

The CN device 2336 may include one or more processor(s) 2338. The processor(s) 2338 may execute instructions such that various operations of the CN device 2336 are performed, as described herein. The processor(s) 2338 may include one or more baseband processors implemented using, for example, a CPU, a DSP, an ASIC, a controller, an FPGA device, another hardware device, a firmware device, or any combination thereof configured to perform the operations described herein.

The CN device 2336 may include a memory 2340. The memory 2340 may be a non-transitory computer-readable storage medium that stores instructions 2342 (which may include, for example, the instructions being executed by the processor(s) 2338). The instructions 2342 may also be referred to as program code or a computer program. The memory 2340 may also store data used by, and results computed by, the processor(s) 2338.

The CN device 2336 may include one or more interface(s) 2344. The interface(s) 2344 may be used to provide input to or output from the CN device 2336. For example, a CN device 2336 may communicate with the network device 2318 on an interface 2348 of the interface(s) 2344 (which, in, for example, NR cases may be an NG interface or in LTE cases may be an SI interface).

The CN device 2336 may include a PDCP retransmission module 2346. The PDCP retransmission module 2346 may be implemented via hardware, software, or combinations thereof. For example, the PDCP retransmission module 2346 may be implemented as a processor, circuit, and/or instructions 2342 stored in the memory 2340 and executed by the processor(s) 2338. In some examples, the PDCP retransmission module 2346 may be integrated within the processor(s) 2338. For example, the PDCP retransmission module 2346 may be implemented by a combination of software components (e.g., executed by a DSP or a general processor) and hardware components (e.g., logic gates and circuitry) within the processor(s) 2338.

The PDCP retransmission module 2316 may be used for various aspects of the present disclosure, for example, aspects of FIG. 7 to FIG. 21.

Embodiments contemplated herein include an apparatus comprising means to perform one or more elements of the method 2100. This apparatus may be, for example, an apparatus of a UE (such as a wireless device 2302 that is a UE, as described herein).

Embodiments contemplated herein include one or more non-transitory computer-readable media comprising instructions to cause an electronic device, upon execution of the instructions by one or more processors of the electronic device, to perform one or more elements of the method 2100. This non-transitory computer-readable media may be, for example, a memory of a UE (such as a memory 2306 of a wireless device 2302 that is a UE, as described herein).

Embodiments contemplated herein include an apparatus comprising logic, modules, or circuitry to perform one or more elements of the method 2100. This apparatus may be, for example, an apparatus of a UE (such as a wireless device 2302 that is a UE, as described herein).

Embodiments contemplated herein include an apparatus comprising: one or more processors and one or more computer-readable media comprising instructions that, when executed by the one or more processors, cause the one or more processors to perform one or more elements of the method 2100. This apparatus may be, for example, an apparatus of a UE (such as a wireless device 2302 that is a UE, as described herein).

Embodiments contemplated herein include a signal as described in or related to one or more elements of the method 2100.

Embodiments contemplated herein include a computer program or computer program product comprising instructions, wherein execution of the program by a processor is to cause the processor to carry out one or more elements of the method 2100. The processor may be a processor of a UE (such as a processor(s) 2304 of a wireless device 2302 that is a UE, as described herein). These instructions may be, for example, located in the processor and/or on a memory of the UE (such as a memory 2306 of a wireless device 2302 that is a UE, as described herein).

Embodiments contemplated herein include an apparatus comprising means to perform one or more elements of the method 2100. This apparatus may be, for example, an apparatus of a base station (such as a network device 2318 that is a base station, as described herein) and/or of a CN (such as the CN device 2336, as described herein). It is further contemplated that this apparatus may be one of many such apparatuses working together in a distributed fashion to perform the one or more elements of any of the method 2100.

Embodiments contemplated herein include one or more non-transitory computer-readable media comprising instructions to cause an electronic device, upon execution of the instructions by one or more processors of the electronic device, to perform one or more elements of the method 2100. This non-transitory computer-readable media may be, for example, a memory of a base station (such as a memory 2340 of a network device 2318 that is a base station, as described herein) and/or of a CN (such as the memory 2340 of a CN device 2336, as described herein). It is further contemplated that the electronic device may be one of many such electronic devices working together in a distributed fashion to perform the one or more elements of any of the method 2100.

Embodiments contemplated herein include an apparatus comprising logic, modules, or circuitry to perform one or more elements of the method 2100. This apparatus may be, for example, an apparatus of a base station (such as a network device 2318 that is a base station, as described herein) and/or of a CN (such as the CN device 2336, as described herein). It is further contemplated that this apparatus may be one of many such apparatuses working together in a distributed fashion to perform the one or more elements of any of FIG. 7 to FIG. 21.

Embodiments contemplated herein include an apparatus comprising: one or more processors and one or more computer-readable media comprising instructions that, when executed by the one or more processors, cause the one or more processors to perform one or more elements of the method 2100. This apparatus may be, for example, an apparatus of a base station (such as a network device 2318 that is a base station, as described herein) and/or of a CN (such as the CN device 2336, as described herein). It is further contemplated that this apparatus may be one of many such apparatuses working together in a distributed fashion to perform the one or more elements of any of method 2100.

Embodiments contemplated herein include a signal as described in or related to one or more elements of the method 2100.

Embodiments contemplated herein include a computer program or computer program product comprising instructions, wherein execution of the program by a processing element is to cause the processing element to carry out one or more elements of the method 2100. The processor may be a processor of a base station (such as a processor(s) 2320 of a network device 2318 that is a base station, as described herein). These instructions may be, for example, located in the processor and/or on a memory of the base station (such as a memory 2322 of a network device 2318 that is a base station, as described herein). The processor may be a processor of a CN device (such as a processor(s) 2338 of a CN device 2336, as described herein). These instructions may be, for example, located in the processor and/or on a memory of the CN device (such as a memory 2340 of a CN device 2336, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for packet data convergence protocol (PDCP) retransmission for cell-free connectivity of a wireless device, the method comprising:
generating, at a transmission (Tx) PDCP entity, a Tx request message comprising an identifier (ID) of the Tx request message, Tx request configuration information, and one or more groups of protocol data units (PDUs) in a PDCP Tx buffer;
in response to the Tx request message, in a Tx unacknowledged mode (UM) radio resource control (RLC) function:
of the one or more groups of PDUs, determining one or more delivered PDUs and one or more non-delivered PDUs within a time-to-live (TTL) period configured by the Tx request configuration information;
generating a delivery Tx report based on the one or more delivered PDUs and the one or more non-delivered PDUs, wherein the delivery Tx report is associated with the ID of the Tx request message; and
after expiration of a time-to-report (TTR) period configured by the Tx request configuration information, sending the delivery Tx report to the Tx PDCP entity; and
in response to the delivery Tx report, at the Tx PDCP entity, determining to retransmit the one or more non-delivered PDUs.

2. The method of claim 1, wherein the Tx UM RLC function is implemented in one or more of a Tx RLC entity and a media access control (MAC) entity.

3. The method of claim 1, wherein the Tx request message comprises a multi-group Tx request message comprising:
a request header including a number groups of the one or more groups of PDUs in the multi-group Tx request message, a respective Tx configuration for each of the one or more groups of PDUs in the multi-group Tx request message, an index value of a first PDU in each of the one or more groups of PDUs in the multi-group Tx request message, and a number of PDUs in each of the one or more groups of PDUs in the multi-group Tx request message; and
a request body comprising the one or more groups of PDUs arranged as indicated in the request header.

4. The method of claim 1, further comprising, at the Tx UM RLC function:
starting a TTL timer corresponding to the TTL period configured by the Tx request configuration information upon receiving the Tx request message at the Tx UM RLC function from the Tx PDCP entity;
during the TTL period, processing RLC service data units (SDUs) corresponding to the one or more groups of PDUs; and
when the TTL timer expires, discarding one or more of the RLC SDUs associated with the TTL timer.

5. The method of claim 4, wherein the TTL timer is configured for one of a group of RLC SDUs, a logical channel, or a logical sub-channel of the logical channel.

6. The method of claim 4, wherein processing the RLC SDUs during the TTL period comprises one or more of buffering the RLC SDUs, segmenting the RLC SDUs, and allocating the RLC SDUs into one or more media access control (MAC) hybrid automatic repeat request (HARQ) processes; and
wherein discarding the one or more of the RLC SDUs comprises performing a discard procedure including:
flushing related RLC SDUs from a buffer;
determining to not allocate the related RLC SDUs to new HARQ processes;
determining whether or not to perform retransmissions associated with existing HARQ processes that include the related RLC SDUs;
releasing the HARQ processes that include only the related RLC SDUs; and
determining not to retransmit any code block groups (CBGs) containing only data of MAC SDUs corresponding to a discarded RLC SDU.

7. The method of claim 1, further comprising, at the Tx UM RLC function:
starting a TTR timer corresponding to the TTR period configured by the Tx request configuration information upon receiving the Tx request message at the Tx UM RLC function from the Tx PDCP entity; and
when the TTR timer expires, generating the delivery Tx report comprising a Tx report ID, a PDU group ID, and an indication selected from a group comprising:
a success indication when all PDUs associated with the PDU group ID are delivered within the TTL period;
a failure indication when all the PDUs associated with the PDU group ID are not delivered within the TTL period; and
a partial success indication when one or more first PDUs associated with the PDU group ID are delivered within the TTL period and one or more second PDUs associated with the PDU group ID are not delivered within the TTL period.

8. The method of claim 7, wherein the TTR timer is configured for one of a group of RLC service data units (SDUs), a logical channel, or a logical sub-channel of the logical channel.

9. The method of claim 7, wherein the TTR timer is periodic such that when it expires for a first PDU group ID it starts over for a second PDU group ID.

10. The method of claim 7, wherein the delivery Tx report comprises one or more of:
a bitmap indicating the one or more delivered PDUs and the one or more non-delivered PDUs;
a number of the one or more delivered PDUs;
an index of a first of the one or more non-delivered PDUs or of a last of the one or more delivered PDUs; and
indices of each of the one or more delivered PDUs or each of the one or more non-delivered PDUs.

11. The method of claim 1, further comprising generating, at the Tx PDCP entity for delivery to the Tx UM RLC function, one or more of:
an update configuration message to update or modify the Tx request configuration information;
a discard command message for the Tx UM RLC function to discard an indicated PDU group or each of the one or more groups of PDUs in the Tx request message; and
a report command message for the Tx UM RLC function to generate the delivery Tx report for the indicated PDU group or each of the one or more groups of PDUs in the Tx request message.

12. The method of claim 1, further comprising, at the Tx PDCP entity:
grouping a plurality of PDUs in the PDCP Tx buffer into the one or more groups of PDUs; and
selecting the TTL period for the one or more groups of PDUs.

13. The method of claim 12, further comprising, at the Tx PDCP entity, selecting the TTL period based on quality of service (QoS) delay budget information.

14. The method of claim 12, further comprising, at the Tx PDCP entity, grouping the plurality of PDUs based on PDU set information available at the Tx PDCP entity.

15. The method of claim 12, wherein the Tx PDCP entity is configured with multiple RLC entities or media access control (MAC) entities implementing the Tx UM RLC function, and wherein the method further comprises selecting, at the Tx PDCP entity, one or more of the multiple RLC entities or MAC entities for routing the one or more groups of PDUs.

16. The method of claim 15, wherein when a plurality of the multiple RLC entities or MAC entities are selected by the Tx PDCP entity for routing the one or more groups of PDUs, the method further comprises duplicating the one or more groups of PDUs or adding redundant packets with forward error correction (FEC) packet coding.

17. The method of claim 12, further comprising performing, at a reception (Rx) PDCP entity, one or more of PDU reordering, PDU duplication discard, and decoding for forward error correction (FEC) packet coding.

18. The method of claim 12, further comprising, in response to receiving the Tx delivery report at the Tx PDCP entity, removing the one or more delivered PDUs from the PDCP Tx buffer, wherein determining to retransmit the one or more non-delivered PDUs comprises handling the one or more non-delivered PDUs along with other PDUs remaining in the PDCP Tx buffer.

19. The method of claim 1, further comprising:
configuring PDCP service data units (SDUs) with a delay budget, wherein the TTL period is less than or equal to the delay budget, and wherein the TTR period is less than the TTL period; and
when the delivery Tx report indicates the one or more non-delivered PDUs are not delivered by a first RLC layer or first media access control (MAC) layer implementing the Tx UM RLC function, sending the one or more non-delivered PDUs by duplication from the Tx PDCP entity to a second RLC layer or MAC layer implementing the Tx UM RLC function.

20. The method of claim 19, further comprising sending a discard command message from the Tx PDCP entity to the first RLC layer or first MAC layer to discard the Tx request message.
